(19) United States
(12) Patent Application Publication
(10) Pub. No.: US 2026/0303537 A1
(43) Pub. Date: Oct. 1, 2026

(54) CONGESTION HANDLING FOR HOLOGRAPHIC COMMUNICATIONS

(71) Applicant: QUALCOMM Incorporated, San Diego, CA (US)

(72) Inventors: Mickaël MONDET, Louannec (FR); Saadallah KASSIR, San Diego, CA (US); Prashanth Haridas HANDE, San Diego, CA (US); Peerapol TINNAKORNSRISUPHAP, San Diego, CA (US)

(21) Appl. No.: 19/089,908

(22) Filed: Mar. 25, 2025

(51) Int. Cl. H04L 47/26; H04L 47/12

(52) U.S. Cl. CPC H04L 47/26; H04L 47/12

(57) ABSTRACT

Methods, systems, and devices for wireless communications are described. Wireless communication devices may utilize techniques that enable explicit congestion notification (ECN) feedback for holographic communications to be routed to a device that transmits packets affected by congestion. For example, a wireless communication device may receive a first set of packets that include at least one packet having an ECN marking. The wireless communication device may transmit a feedback message to an application server including ECN feedback and an identifier (ID) corresponding to a wireless communication device that is the source of the at least one packet having the ECN marking. The application server may provide the ECN feedback to the source wireless communication device based on the ID included in the feedback message. The source wireless communication device may modify a data rate associated with the traffic flow in accordance with the ECN feedback received from the application server.

### FIELD OF TECHNOLOGY

The following relates to wireless communications, including congestion handling for holographic communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first wireless communication device is described. The method may include receiving a first set of packets of a traffic flow associated with holographic communications, where at least one packet of the first set of packets includes an explicit congestion notification marking and transmitting, based on the explicit congestion notification marking, a feedback message including congestion information corresponding to the traffic flow, the feedback message further including an identifier of a second wireless communication device that is a source of the first set of packets.

A first wireless communication device for wireless communications is described. The first wireless communication device may include one or more memories storing processor executable code, and one or more processors coupled with the one or more memories. The one or more processors may individually or collectively be operable to execute the code to cause the first wireless communication device to receive a first set of packets of a traffic flow associated with holographic communications, where at least one packet of the first set of packets includes an explicit congestion notification marking and transmit, based on the explicit congestion notification marking, a feedback message including congestion information corresponding to the traffic flow, the feedback message further including an identifier of a second wireless communication device that is a source of the first set of packets.

Another first wireless communication device for wireless communications is described. The first wireless communication device may include means for receiving a first set of packets of a traffic flow associated with holographic communications, where at least one packet of the first set of packets includes an explicit congestion notification marking and means for transmitting, based on the explicit congestion notification marking, a feedback message including congestion information corresponding to the traffic flow, the feedback message further including an identifier of a second wireless communication device that is a source of the first set of packets.

A non-transitory computer-readable medium storing code for wireless communications is described. The code may include instructions executable by one or more processors to receive a first set of packets of a traffic flow associated with holographic communications, where at least one packet of the first set of packets includes an explicit congestion notification marking and transmit, based on the explicit congestion notification marking, a feedback message including congestion information corresponding to the traffic flow, the feedback message further including an identifier of a second wireless communication device that is a source of the first set of packets.

In some examples of the method, wireless communication devices, and non-transitory computer-readable medium described herein, transmitting the feedback message may include operations, features, means, or instructions for transmitting the feedback message via a first channel that may be different from a second channel associated with the holographic communications.

In some examples of the method, wireless communication devices, and non-transitory computer-readable medium described herein, transmitting the feedback message may include operations, features, means, or instructions for transmitting a second set of packets associated with the holographic communications, the second set of packets including the feedback message including the congestion information and the identifier of the second wireless communication device.

In some examples of the method, wireless communication devices, and non-transitory computer-readable medium described herein, the congestion information and the identifier of the second wireless communication device may be included in one or more headers of the second set of packets.

In some examples of the method, wireless communication devices, and non-transitory computer-readable medium described herein, one or more packets of the second set of packets include the feedback message including the congestion information and the identifier of the second wireless communication device.

In some examples of the method, wireless communication devices, and non-transitory computer-readable medium described herein, the feedback message further includes respective congestion information corresponding to one or more additional traffic flows and one or more respective identifiers of additional wireless communications devices that may be sources of the one or more additional traffic flows.

In some examples of the method, wireless communication devices, and non-transitory computer-readable medium described herein, the feedback message includes the respective congestion information and the one or more respective identifiers based on congestion associated with the traffic flow, congestion associated with the one or more additional traffic flows, or any combination thereof.

In some examples of the method, wireless communication devices, and non-transitory computer-readable medium described herein, transmitting the feedback message may include operations, features, means, or instructions for transmitting a second set of packets associated with the holographic communications, the second set of packets including the feedback message that that further includes the respective congestion information and the one or more respective identifiers.

In some examples of the method, wireless communication devices, and non-transitory computer-readable medium described herein, transmitting the feedback message may include operations, features, means, or instructions for transmitting the feedback message via a first channel that may be different from a second channel associated with the holographic communications.

A method for wireless communications by a first wireless communication device is described. The method may include transmitting a first set of packets of a traffic flow associated with holographic communications, receiving a feedback message including congestion information that is based on an explicit congestion notification marking of the first set of packets, the feedback message further including an identifier of the first wireless communication device, where the feedback message is received based on the identifier, and modifying a data rate associated with the traffic flow in accordance with the congestion information.

A first wireless communication device for wireless communications is described. The first wireless communication device may include one or more memories storing processor executable code, and one or more processors coupled with the one or more memories. The one or more processors may individually or collectively be operable to execute the code to cause the first wireless communication device to transmit a first set of packets of a traffic flow associated with holographic communications, receive a feedback message including congestion information that is based on an explicit congestion notification marking of the first set of packets, the feedback message further including an identifier of the first wireless communication device, where the feedback message is received based on the identifier, and modify a data rate associated with the traffic flow in accordance with the congestion information.

Another first wireless communication device for wireless communications is described. The first wireless communication device may include means for transmitting a first set of packets of a traffic flow associated with holographic communications, means for receiving a feedback message including congestion information that is based on an explicit congestion notification marking of the first set of packets, the feedback message further including an identifier of the first wireless communication device, where the feedback message is received based on the identifier, and means for modifying a data rate associated with the traffic flow in accordance with the congestion information.

A non-transitory computer-readable medium storing code for wireless communications is described. The code may include instructions executable by one or more processors to transmit a first set of packets of a traffic flow associated with holographic communications, receive a feedback message including congestion information that is based on an explicit congestion notification marking of the first set of packets, the feedback message further including an identifier of the first wireless communication device, where the feedback message is received based on the identifier, and modify a data rate associated with the traffic flow in accordance with the congestion information.

In some examples of the method, wireless communication devices, and non-transitory computer-readable medium described herein, receiving the feedback message may include operations, features, means, or instructions for receiving the feedback message via a first channel that may be different from a second channel associated with the holographic communications.

In some examples of the method, wireless communication devices, and non-transitory computer-readable medium described herein, receiving the feedback message may include operations, features, means, or instructions for receiving a second set of packets associated with the holographic communications, the second set of packets including the feedback message including the congestion information and the identifier of the first wireless communication device.

In some examples of the method, wireless communication devices, and non-transitory computer-readable medium described herein, the congestion information and the identifier of the first wireless communication device may be included in one or more headers of the second set of packets.

In some examples of the method, wireless communication devices, and non-transitory computer-readable medium described herein, one or more packets of the second set of packets include the feedback message including the congestion information and the identifier of the first wireless communication device.

In some examples of the method, wireless communication devices, and non-transitory computer-readable medium described herein, the feedback message further includes respective congestion information corresponding to one or more additional traffic flows and one or more respective identifiers of additional wireless communications devices that may be sources of packets of the one or more additional traffic flows.

Some examples of the method, wireless communication devices, and non-transitory computer-readable medium described herein may further include operations, features, means, or instructions for modifying the data rate based on the respective congestion information and the one or more respective identifiers.

In some examples of the method, wireless communication devices, and non-transitory computer-readable medium described herein, the feedback message includes the respective congestion information and the one or more respective identifiers based on congestion associated with the traffic flow, congestion associated with the one or more additional traffic flows, or any combination thereof.

In some examples of the method, wireless communication devices, and non-transitory computer-readable medium described herein, receiving the feedback message may include operations, features, means, or instructions for receiving a second set of packets associated with the holographic communications, the second set of packets including the feedback message that that further includes the respective congestion information and the one or more respective identifiers.

In some examples of the method, wireless communication devices, and non-transitory computer-readable medium described herein, receiving the feedback message may include operations, features, means, or instructions for receiving the feedback message via a first channel that may be different from a second channel associated with the holographic communications.

Some examples of the method, wireless communication devices, and non-transitory computer-readable medium described herein may further include operations, features, means, or instructions for receiving a second feedback message including respective congestion information corresponding to one or more additional traffic flows and one or more respective identifiers of additional wireless communications devices that may be sources of packets of the one or more additional traffic flows.

Some examples of the method, wireless communication devices, and non-transitory computer-readable medium described herein may further include operations, features, means, or instructions for ignoring the second feedback message based on the identifier of the first wireless communication device being different from the one or more respective identifiers.

Some examples of the method, wireless communication devices, and non-transitory computer-readable medium described herein may further include operations, features, means, or instructions for calculating an estimated data rate based on the respective congestion information corresponding to the one or more additional traffic flows.

Some examples of the method, wireless communication devices, and non-transitory computer-readable medium described herein may further include operations, features, means, or instructions for transmitting one or more messages indicating the estimated data rate, a quality of service (QoS) flow identifier, a logical channel identifier, or any combination thereof, where the one or more messages include a radio resource control message, a medium access control (MAC) control element, uplink control information, or any combination thereof.

A method for wireless communication by an application server is described. The method may include obtaining a first set of packets of a traffic flow associated with holographic communications between a set of multiple wireless communication devices, where the first set of packets is obtained from a first wireless communication device of the set of multiple wireless communication devices, outputting a second set of packets of the traffic flow, the second set of packets corresponding to the first set of packets and output to each wireless communication device of the set of multiple wireless communication devices, obtaining a first feedback message including congestion information that is based on an explicit congestion notification marking of the first set of packets, the first feedback message further including one or more respective identifiers of one or more wireless communication devices of the set of multiple wireless communication devices, and outputting a second feedback message based on the congestion information and the one or more respective identifiers of the one or more wireless communication devices included in the first feedback message.

An application server for wireless communication is described. The application server may include one or more memories storing processor executable code, and one or more processors coupled with the one or more memories. The one or more processors may individually or collectively be operable to execute the code to cause the application server to obtain a first set of packets of a traffic flow associated with holographic communications between a set of multiple wireless communication devices, where the first set of packets is obtained from a first wireless communication device of the set of multiple wireless communication devices, output a second set of packets of the traffic flow, the second set of packets corresponding to the first set of packets and output to each wireless communication device of the set of multiple wireless communication devices, obtain a first feedback message including congestion information that is based on an explicit congestion notification marking of the first set of packets, the first feedback message further including one or more respective identifiers of one or more wireless communication devices of the set of multiple wireless communication devices, and output a second feedback message based on the congestion information and the one or more respective identifiers of the one or more wireless communication devices included in the first feedback message.

Another application server for wireless communication is described. The application server may include means for obtaining a first set of packets of a traffic flow associated with holographic communications between a set of multiple wireless communication devices, where the first set of packets is obtained from a first wireless communication device of the set of multiple wireless communication devices, means for outputting a second set of packets of the traffic flow, the second set of packets corresponding to the first set of packets and output to each wireless communication device of the set of multiple wireless communication devices, means for obtaining a first feedback message including congestion information that is based on an explicit congestion notification marking of the first set of packets, the first feedback message further including one or more respective identifiers of one or more wireless communication devices of the set of multiple wireless communication devices, and means for outputting a second feedback message based on the congestion information and the one or more respective identifiers of the one or more wireless communication devices included in the first feedback message.

A non-transitory computer-readable medium storing code for wireless communication is described. The code may include instructions executable by one or more processors to obtain a first set of packets of a traffic flow associated with holographic communications between a set of multiple wireless communication devices, where the first set of packets is obtained from a first wireless communication device of the set of multiple wireless communication devices, output a second set of packets of the traffic flow, the second set of packets corresponding to the first set of packets and output to each wireless communication device of the set of multiple wireless communication devices, obtain a first feedback message including congestion information that is based on an explicit congestion notification marking of the first set of packets, the first feedback message further including one or more respective identifiers of one or more wireless communication devices of the set of multiple wireless communication devices, and output a second feedback message based on the congestion information and the one or more respective identifiers of the one or more wireless communication devices included in the first feedback message.

In some examples of the method, application servers, and non-transitory computer-readable medium described herein, obtaining the first feedback message may include operations, features, means, or instructions for obtaining the first feedback message via a first channel that may be different from a second channel associated with the holographic communications, the first feedback message including a first identifier of the first wireless communication device, where outputting the second feedback message includes and outputting the second feedback message to the first wireless communication device via the first channel and in accordance with the first feedback message including the first identifier.

In some examples of the method, application servers, and non-transitory computer-readable medium described herein, obtaining the first feedback message may include operations, features, means, or instructions for obtaining a third set of packets associated with the holographic communications, the third set of packets including the first feedback message, the first feedback message including a first identifier of the first wireless communication device, where outputting the second feedback message includes and outputting a fourth set of packets including the second feedback message, the fourth set of packets output to each wireless communication device of the set of multiple wireless communication devices.

In some examples of the method, application servers, and non-transitory computer-readable medium described herein, the congestion information and the one or more respective identifiers may be included in one or more headers of the third set of packets.

In some examples of the method, application servers, and non-transitory computer-readable medium described herein, one or more packets of the third set of packets include the first feedback message including the congestion information and the one or more respective identifiers.

In some examples of the method, application servers, and non-transitory computer-readable medium described herein, obtaining the first feedback message may include operations, features, means, or instructions for obtaining a third set of packets associated with the holographic communications, the third set of packets including the first feedback message, the first feedback message including a first identifier of the first wireless communication device, where outputting the second feedback message includes, outputting a fourth set of packets including the second feedback message, the fourth set of packets output to the first wireless communication device based on the first identifier, and outputting a fifth set of packets that exclude the second feedback message, the fifth set of packets output to other wireless communication devices of the set of multiple wireless communication devices.

In some examples of the method, application servers, and non-transitory computer-readable medium described herein, obtaining the first feedback message may include operations, features, means, or instructions for obtaining the first feedback message via a first channel that may be different from a second channel associated with the holographic communications, where the first feedback message further includes respective congestion information corresponding to one or more additional traffic flows and one or more other respective identifiers from among the one or more respective identifiers corresponding to one or more other wireless communications devices different from the first wireless communication device and that may be sources of packets of the one or more additional traffic flows, where outputting the second feedback message includes and outputting the second feedback message to the one or more other wireless communications devices corresponding to the one or more other respective identifiers.

In some examples of the method, application servers, and non-transitory computer-readable medium described herein, obtaining the first feedback message may include operations, features, means, or instructions for obtaining a third set of packets associated with the holographic communications, the third set of packets including the first feedback message, where the first feedback message further includes respective congestion information corresponding to one or more additional traffic flows and one or more other respective identifiers from among the one or more respective identifiers corresponding to one or more other wireless communications devices different from the first wireless communication device and that may be sources of packets of the one or more additional traffic flows, where outputting the second feedback message includes and outputting a fourth set of packets including the second feedback message, the fourth set of packets output to each wireless communication device of the set of multiple wireless communication devices.

In some examples of the method, application servers, and non-transitory computer-readable medium described herein, the first feedback message further includes respective congestion information corresponding to one or more additional traffic flows and one or more other respective identifiers from among the one or more respective identifiers corresponding to one or more other wireless communications devices different from the first wireless communication device that may be sources of packets of the one or more additional traffic flows and the method, apparatuses, and non-transitory computer-readable medium may include further operations, features, means, or instructions for modifying the congestion information, the one or more other respective identifiers, or both, included in the second feedback message based on the first feedback message including the respective congestion information and the one or more other respective identifiers of the one or more other wireless communications devices.

In some examples of the method, application servers, and non-transitory computer-readable medium described herein, obtaining the first feedback message may include operations, features, means, or instructions for obtaining the first feedback message via a first channel that may be different from a second channel associated with the holographic communications, the first feedback message including a first identifier of the first wireless communication device, where outputting the second feedback message includes and outputting the second feedback message via the first channel to one or more other wireless communication devices of the set of multiple wireless communication devices.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports congestion handling for holographic communications in accordance with one or more aspects of the present disclosure.

FIG. 2 shows an example of a wireless communications system that supports congestion handling for holographic communications in accordance with one or more aspects of the present disclosure.

FIGS. 3A and 3B show examples of process flows that supports congestion handling for holographic communications in accordance with one or more aspects of the present disclosure.

FIGS. 3C and 3D show example of signaling diagrams that supports congestion handling for holographic communications in accordance with one or more aspects of the present disclosure.

FIG. 4 shows an example of a process flow that supports congestion handling for holographic communications in accordance with one or more aspects of the present disclosure.

FIGS. 5A and 5B show examples of process flows that support congestion handling for holographic communications in accordance with one or more aspects of the present disclosure.

FIGS. 6A and 6B show examples of process flows that support congestion handling for holographic communications in accordance with one or more aspects of the present disclosure.

FIGS. 7A and 7B show examples of process flows that support congestion handling for holographic communications in accordance with one or more aspects of the present disclosure.

FIGS. 8 and 9 show block diagrams of devices that support congestion handling for holographic communications in accordance with one or more aspects of the present disclosure.

FIG. 10 shows a block diagram of a communications manager that supports congestion handling for holographic communications in accordance with one or more aspects of the present disclosure.

FIG. 11 shows a diagram of a system including a device that supports congestion handling for holographic communications in accordance with one or more aspects of the present disclosure.

FIGS. 12 and 13 show block diagrams of devices that support congestion handling for holographic communications in accordance with one or more aspects of the present disclosure.

FIG. 14 shows a block diagram of a communications manager that supports congestion handling for holographic communications in accordance with one or more aspects of the present disclosure.

FIG. 15 shows a diagram of a system including a device that supports congestion handling for holographic communications in accordance with one or more aspects of the present disclosure.

FIGS. 16 through 18 show flowcharts illustrating methods that support congestion handling for holographic communications in accordance with one or more aspects of the present disclosure.

### DETAILED DESCRIPTION

Some wireless communications systems may support holographic communications between two or more users. Holographic communications may refer to technologies that support the transmission of three-dimensional (3D) images by one user to one or more other users (and their corresponding wireless communication devices), enabling the reproduction of the 3D images as a realistic representation of an individual and/or objects, which may enable interactions with such individuals and objects as if they were physically present. For example, holographic communications may include video capture via a user equipment (UE) (and/or one or more peripheral devices), where corresponding video frames (e.g., including multiple packets) may be transmitted to an application server via one or more radio access technologies (RATs) (such as via a fifth generation (5G) new radio (NR) system, among other examples). The video frames may be received by other UEs (and/or peripheral devices) included in the holographic communications session, which may be rendered and presented to a user.

In some cases, wireless communications systems supporting holographic communications may implement a selective forwarding unit (SFU) architecture. An SFU may be an example of a media server or other type of server that may be configured to support, for example, group calls, videoconferencing (e.g., multi-party conferencing), and live broadcasts, among other examples. In accordance with the SFU architecture, an application server may forward (e.g., immediately forward) frames associated with the holographic communications (e.g., audio and video streams) to each of one or more other UEs. In such examples, each UE may receive the frames of all other UEs, and the frames may be used for scene rendering and display (e.g., via a headset or one or more other peripheral devices). As an example, for each time interval (e.g., for each 1/frame per second (fps)) of a holographic communications session including N users (e.g., UEs, devices), each user may transmit one video frame (e.g., a data frame) to the application server, and each user may also receive N−1 video frames from the application server.

Some wireless communications systems may further support one or more congestion indications (e.g., explicit congestion notification (ECN) markings) between different wireless communication devices. For example, a congestion condition for a traffic flow may be determined (e.g., by a radio access network (RAN)), and uplink and/or downlink packets may have ECN markings added (e.g., at the Internet Protocol (IP) layer) to indicate the congestion. In some cases, the network may send such packets including the ECN markings to a UE (e.g., in the downlink) or to a user plane function (UPF) (e.g., in the uplink). Additionally, or alternatively, the congestion may be detected for an uplink/downlink flow, and the network may provide congestion information to a UPF. The UPF may accordingly include ECN markings for uplink and downlink packets of the flow (e.g., at the IP layer). In any case, when ECN markings are identified by a wireless communication device associated with the congested flow, the wireless communication device may transmit feedback (e.g., ECN feedback) indicating, for example, information about the congestion and/or packet loss. Further, after receiving the ECN feedback, a transmitting wireless communication device associated with the traffic flow may perform rate adaptation, for example, to mitigate the effects of the congestion.

However, in the example of holographic communications (such as with systems that implement the SFU architecture), ECN markings may not be received by a wireless communication device that transmitted a packet, and the transmitting wireless communication device may thus not be aware of the detected congestion corresponding to an ECN marking (e.g., the transmitting wireless communication device may not be aware of the ECN markings or the corresponding ECN feedback). More specifically, congestion may affect a message received from a first UE by a second UE (e.g., that is forwarded through an application server). Feedback corresponding to such congestion may be sent to the application server (e.g., as part of the SFU deployment) but may not be provided to any other wireless communication device (such as the first UE) that may perform rate adaptation. That is, ECN feedback may become “stuck” at the application server. The congestion may therefore go unaddressed, which may affect the quality of the holographic communications, thereby impacting user experience and possibly result in various issues associated with uncontrolled congestion and packet loss.

As described herein, techniques may enable ECN feedback to be provided to respective wireless communication devices involved in a holographic communications session, which may enable some wireless communication devices to perform rate adaptation to mitigate such congestion. In some cases, the ECN feedback may be signaled from a UE to one or more UEs of the holographic communications session. For example, a receiving wireless communication device (e.g., a UE) may detect congestion for a traffic flow with another wireless communication device (e.g., based on a presence of ECN markings), and the receiving wireless communication device may transmit an ECN feedback message via out-of-band signaling to an application server. The application server may forward the feedback to the other wireless communication device(s) that transmitted the packets associated with the traffic flow. In such cases, the ECN feedback message may include an identifier (ID) of the transmitting wireless communication device, which the application server may use for notifying the transmitting wireless communication device of the congestion (e.g., by forwarding the ECN feedback).

Additionally, or alternatively, the congestion may be detected for downlink packets of a traffic flow, and the receiving wireless communication device may transmit the feedback message indicating the ECN feedback to the application server via in-band signaling, where the feedback message may additionally include an ID of the transmitting wireless communication device and may be forwarded by the application server to each other wireless communication device included in the holographic communications. For instance, the feedback message may be handled by the application server as another holographic communications message from the receiving wireless communication device, and the application server may forward the ECN feedback to the transmitting wireless communication device, while removing the ECN feedback information for data forward to each other wireless communication device included in the holographic communication session. The transmitting wireless communication device may check the ID included in the ECN feedback message and may perform rate reduction based on the congestion corresponding to that wireless communication device's traffic flow (and as indicated by the ECN feedback). In some examples, the feedback message indicating the ECN feedback may include the respective IDs of one or more other wireless communication devices, which may enable multiple wireless communication devices to be aware of the congestion associated with one or more flows of the holographic communications. For example, a first wireless communication device receiving the ECN feedback may have an ID that is the same as an ID included in the ECN feedback message, and the first wireless communication device may perform rate reduction, whereas other wireless communication devices having different IDs may ignore the ECN feedback, but may be notified of the congestion affecting the first wireless communication device.

In some aspects, one or more wireless communication devices that are not directly affected by congestion may receive an indication that another wireless communication device may be performing rate reduction. Such an indication may enable each wireless communication devices to be aware of congestion affecting the holographic communications. For example, the ECN feedback message may be transmitted as out-of-band signaling, and the application server may transmit the ECN feedback to one or more wireless communication devices that are different from the wireless communication device transmitting packets for the congested traffic flow. In some cases, the wireless communication devices receiving the ECN feedback may estimate and/or predict one or more future rate changes, and such information may be signaled to a corresponding RAN.

Particular aspects of the subject matter described in this disclosure may be implemented to realize one or more of the following potential advantages. For example, enabling one or more wireless communication devices to receive ECN feedback may improve the quality of holographic communications through the reduction of packet loss and delays (e.g., by performing rate reduction or other techniques). For example, the described techniques may be used to enable ECN feedback to reach one or more transmitting wireless communication devices (e.g., UEs, other devices) for holographic communications in a system that supports an SFU architecture. Additionally, other wireless communication devices may be made aware of a possible rate change by one or more wireless communication device included in the holographic communications session, which may enable improved flexibility and adaptability to network congestion affecting multiple devices. As such, the holographic communications may be made more robust using the described techniques, which may further improve communications efficiency and resource usage in a system, and which may minimize or reduce delays associated with the retransmission of packets and/or forward error correction.

Aspects of the disclosure are initially described in the context of wireless communications systems and described with reference to signaling diagrams and process flows. Aspects of the disclosure are further illustrated by and described with reference to apparatus diagrams, system diagrams, and flowcharts that relate to congestion handling for holographic communications.

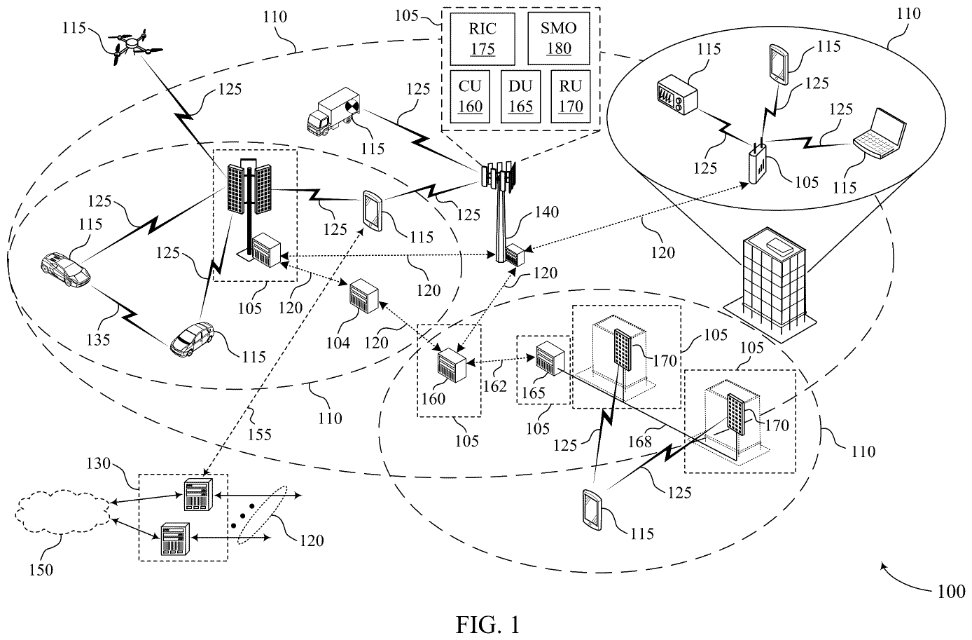

FIG. 1 shows an example of a wireless communications system 100 that supports congestion handling for holographic communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support congestion handling for holographic communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques that enable ECN feedback for holographic communications to be routed to a device that transmits packets affected by congestion. For example, a wireless communication device (e.g., a UE 115) may receive a first set of packets that include at least one packet having an ECN marking (e.g., within a header of the packet). The UE 115 may transmit a feedback message to an application server, where the feedback message may include ECN feedback and an ID corresponding to a UE 115 that is the source of the at least one packet having the ECN marking. The application server may provide the ECN feedback to the source UE 115 based on the ID included in the feedback message. The source UE 115 may modify a data rate (e.g., reduce a data rate) associated with the traffic flow in accordance with the ECN feedback received from the application server. In some cases, the feedback message may include IDs of one or more other UEs 115, and the application server may accordingly send the feedback message to multiple UEs 115, which may either ignore the ECN feedback (e.g., if the ID included in the feedback message is different from an ID of the UE 115) or may perform rate adaptation (e.g., if the ID included in the feedback message is the same as ID of the UE 115).

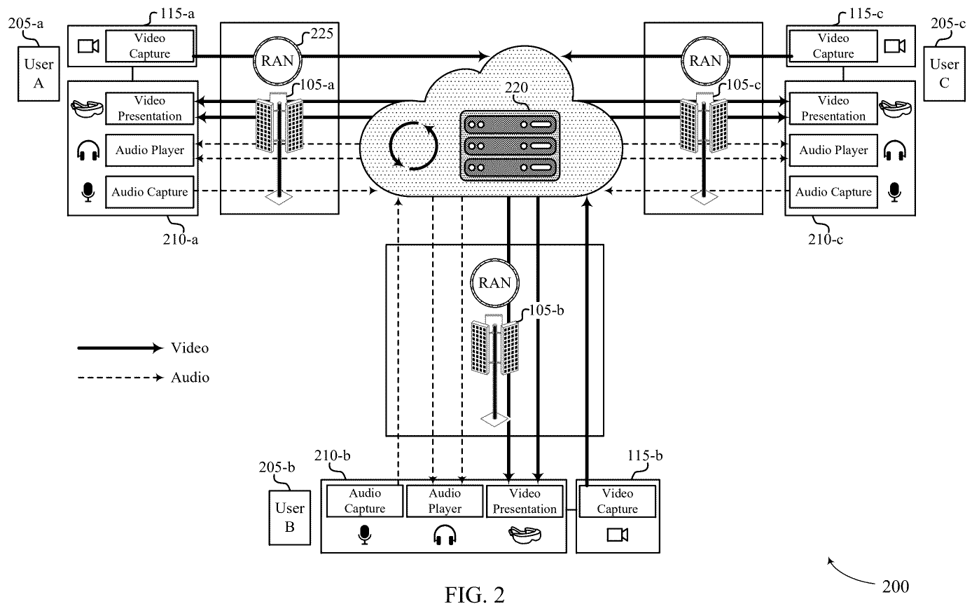

FIG. 2 shows an example of a wireless communications system 200 that supports congestion handling for holographic communications in accordance with one or more aspects of the present disclosure. The wireless communications system 200 may implement, or be implemented by, one or more aspects of the wireless communications system 100. In some aspects, the wireless communications system 200 may support techniques for the coordination of holographic communications between wireless communication devices.

Holographic communications may refer technologies that enable the transmission of 3D images between users 205, allowing for the realistic representation and interaction with individuals or objects as if they were physically present. Such technology may leverage aspects of holography in which 3D images are created by recording light patterns and reconstructing the light patterns. Some holographic communications techniques may include, for example, processes for 3D image capture and reconstruction, where cameras and/or sensors are used to capture 3D information of a subject, including depth, texture, and color. Data associated with the 3D information may be transmitted and reconstructed using holographic displays and/or projectors at one or more receiving devices. Based on the rendered information, holographic communications may provide a sense of physical presence for users. As such, holographic communications may be beneficial in various applications and industries. For instance, holographic communications may be utilized for virtual meetings, teleconferences, and collaborative environments where spatial awareness and the ability to perceive gestures and expressions in 3D are important. Moreover, holographic communications may provide enhancements to various fields, including, for example, business and telepresence (e.g., for immersive and effective remote meetings, presentations, and conferences), entertainment and media (e.g., providing enhanced forms of viewer engagement and interactive experiences), education and training (e.g., providing engaging and interactive learning experiences, such as virtual classrooms and simulations), healthcare (e.g., telemedicine and remote consultations with a more realistic representation of patients and/or medical data), and technology development (e.g., development of computational power, bandwidth, and display technologies), to name a few. In some examples, holographic communications may involve two or more users 205, and the data associated with the holographic communications may be represented as holograms in extended reality (XR) scenes (where XR may include or be associated with virtual reality (VR), augmented reality (AR), mixed reality (MR), and/or similar technologies).

The wireless communications system 200 illustrates a system that supports holographic communications between multiple users 205, where each user 205 may be associated with one or more wireless communication devices, such as a UE 115 and/or one or more peripheral devices 210. As an example, a first user 205-a (e.g., user A) may be associated with a first UE 115-a and/or one or more devices 210-a (e.g., peripheral devices), where the UE 115-a and/or the devices 210-a may be an example of a UE 115 described with reference to FIG. 1. Similarly, a second user 205-b (e.g., user B) may be associated with a second UE 115-b and one or more devices 210-b (e.g., peripheral devices), and a third user 205-c (e.g., user C) may be associated with a third UE 115-c and one or more devices 210-c (e.g., peripheral devices). Some aspects of the present disclosure may be described with reference to a user transmitting/receiving packets or performing some operations, and it will be clear to a person having ordinary skill in the art that such descriptions refer to the devices and/or UEs 115 associated with a user that transmit/receive packets or perform some operations in association with one or more network entities 105 and RATs. For example, a user transmitting one or more packets is understood to mean that a UE 115 and/or one or more devices associated with the user transmit the one or more packets, which may be signaled via one or more network entities 105 that operate in accordance with one or more RATs.

The one or more devices 210 associated with each user 205 may include, for example, one or more headsets, booths, tables, projectors, displays, speakers, and/or other types of devices and components that support and/or are configured for rendering of audio and video associated with holographic communications. Such devices may be portable or unportable. As an illustrative example, the one or more devices 210-a may include a headset display that supports video presentation, speakers that support audio presentation, and a microphone that supports audio capture. Further, the UE 115-a may support video capture associated with the holographic communications. In some cases, the UE 115-a may be coupled with (e.g., via a wireless connection, via a wired connection, or both) the one or more device 210-a. In some cases, a UE 115-a may be capable of performing the operations associated with the holographic communications. For example, the UE 115-a may be capable of video capture, video rendering and presentation, audio playback, and/or audio capture. As such, the techniques, functions, and capabilities described herein with reference to a UE 115 may similarly apply to the one or more devices 210, and vice versa. In some examples, one or more UEs 115 and/or the one or more devices 210 may be associated with an application client for the holographic communications, where the application client may communicate sets of frames (where each frame may be associated with one or multiple packets) with the application server.

In some examples, data associated with the UEs 115 and the one or more devices 210 may be communicated via one or more network entities 105 (e.g., a network entity 105-a, a network entity 105-b, a network entity 105-c), which may each be an example of a network entity 105 described with reference to FIG. 1. As an example, the UE 115-a may utilize one or more application to capture video associated with the holographic communications (e.g., using one or more cameras), and the UE 115-a may transmit a set of frames (e.g., video frames, data frames) to an application server 220 via a network entity 105-a. Similarly, the one or more devices 210-a may exchange signaling with the application server 220 via the network entity 105-a. For example, a headset that supports video presentation may receive a set of frames (e.g., video frames, which may be referred to as data frames) from the application server 220 that may be rendered for the holographic communications, and an audio player may receive a set of frames (e.g., audio frames) from the application server 220 that may provide corresponding audio for the holographic communications. In any case, the network entity 105-a may be associated with a RAN 225 (such as a 5G NR network) and may operate in accordance with one or more RATs associated with the RAN 225. In some examples, a UE 115 may receive the frames from the application server 220, and the UE 115 may provide the frames to the one or more devices 210, or the UE 115 may be configured to render audio and video using the received frames.

In some aspects, the wireless communications system 200 may implement an SFU architecture. An SFU may be an example of a media server or other type of server that may be configured to support group calls, videoconferencing (e.g., multi-party conferencing), and live broadcasts, among other examples. In the SFU architecture, every connected device may transmit a set of outgoing media streams to a server (e.g., an application server 220), and the set of streams is forwarded to every other device by the SFU. As an example, an application server 220 (e.g., associated with the SFU architecture) may forward (e.g., immediately forward) frames associated with the holographic communications to each UE 115 (e.g., UE 115-a, UE 115-b, UE 115-c) and/or the one or more devices 210 (e.g., devices 210-a, devices 210-b, devices 210-c). In such examples, each UE 115 may receive the frames of all other UEs 115, and the frames may be used for scene rendering and display by the UE 115 and/or the one or more devices 210 (e.g., via a headset or one or more other peripheral devices). Here, for each time interval (e.g., each 1/fps, where fps may be, for example, 60 fps) of a holographic communications session including N users 205, each UE 115 may transmit one frame (e.g., video frame, data frame) to the application server, and each UE 115 (and/or one or more devices 210) may receive N−1 frames (e.g., N−1 video frames) from the application server 220. Put differently, frames may be transmitted periodically to the application server 220, and the application server 220 may forward the frames to all other users 205 (e.g., UEs 115 and/or devices 210) immediately.

Additionally, the wireless communications system 200 may support congestion indications (e.g., ECN markings) between different devices. For example, ECN markings may be used to help identify and control congestion (e.g., congestion causing delays in packet transmission and/or delivery, congestion resulting in packet loss, or the like) in the wireless communications system 200, and corresponding ECN feedback may help to reduce packet loss and delays. An ECN marking may refer to one or more bits (e.g., two bits) included in a packet header (e.g., an IP header) to indicate congestion. For example, a congestion condition for a traffic flow may be determined (e.g., by a RAN 225), and uplink and/or downlink packets may have ECN markings added (e.g., at the IP layer) to indicate the congestion, where the RAN 225 may send such packets including the ECN markings to either a UE 115 (e.g., in the downlink) or to a UPF (e.g., in the uplink). Additionally, or alternatively, the congestion may be detected for an uplink/downlink flow and the RAN 225 may indicate congestion information to a UPF. The UPF may than include ECN markings for uplink and downlink packets of the flow (e.g., at the IP layer). In some examples, one or more techniques may be used to detect the congestion, such as an active queue management (AQM) detection technique, among other examples. ECN techniques may be used for applications such as cloud gaming, AR/VR, and real-time video (such as with holographic communications), among other examples. In any case, when ECN markings are identified by a receiving device (e.g., a UE 115) associated with the congested flow, the device may transmit feedback (e.g., ECN feedback) indicating, for example, information about the congestion and/or packet loss. After receiving the ECN feedback, the transmitting device may perform rate adaptation to mitigate the effects of such congestion.

However, in the example of holographic communications (such as in systems that implement the SFU architecture), ECN markings may not be received by a device that transmitted a packet, and such devices may not be aware of the detected congestion corresponding to an ECN marking. More specifically, congestion may affect a message received from a first UE 115 by a second UE 115 (e.g., that is forwarded through an application server 220). ECN feedback corresponding to such congestion (e.g., for various messages from the second UE 115) may be sent to the application server in accordance with the SFU deployment, but the ECN feedback may not be provided back to the second UE 115, for example, to perform rate adaptation (e.g., rate reduction) to mitigate the congestion. Such congestion may therefore go unaddressed and may affect the quality of the holographic communications for one or more users.

As described herein, techniques may enable ECN feedback to be provided to respective UEs 115 involved in a holographic communications session, which may enable some UEs 115 to perform rate adaptation to mitigate such congestion. In some cases, the ECN feedback may be signaled from a UE 115 to one or more UEs 115 of the holographic communications session. For example, a receiving UE 115 may detect congestion for a traffic flow with another UE 115 (e.g., based on a presence of ECN markings), and the receiving UE 115 may transmit an ECN feedback message via out-of-band signaling to an application server 220. The application server 220 may send the feedback to the other UE 115 (or other UEs 115) that transmitted the packets associated with the traffic flow. In such cases, the ECN feedback message may include an ID of the transmitting UE 115, which the application server 220 may use for notifying the transmitting UE 115 of the congestion (e.g., via the forwarded ECN feedback).

Additionally, or alternatively, the congestion may be detected for downlink packets of a traffic flow, and the receiving UE 115 may transmit the ECN feedback message to the application server 220 via in-band signaling, where the ECN feedback message may include an ID of the transmitting UE 115 and may be forwarded by the application server 220 to each other UE 115 included in the holographic communications session. For instance, the ECN feedback message may be forwarded by the application server 220 as a holographic communications message from the receiving UE 115, and the application server 220 may forward the ECN feedback message to the transmitting UE 115 (while removing the ECN feedback information for data forward to each other UE 115 in the holographic communication session). The transmitting UE 115 may check the ID included in the ECN feedback message and may perform rate reduction based on the congestion corresponding to the traffic flow of that UE 115 (and as indicated by the ECN feedback message). In some examples, the ECN feedback message may include the respective IDs of one or more UEs 115, which may enable multiple UEs 115 to be aware of the congestion affecting one or more flows of the holographic communications session. For example, a UE 115 receiving the ECN feedback may have an ID that is the same as an ID included in the ECN feedback message, and that UE 115 may perform rate reduction, whereas one or more other UEs 115 having different IDs may ignore the ECN feedback.

In some aspects, one or more UEs 115 that are not directly affected by congestion may be made aware that another UE 115 may be performing rate reduction. Such an indication may enable all UEs 115 to be aware of congestion affecting the holographic communications (which involves each of the UEs 115). For example, the ECN feedback message may be transmitted as out-of-band signaling, and the application server 220 may transmit the ECN feedback to one or more UEs 115 that are different from the UE 115 transmitting packets for the congested traffic flow. In some cases, the UEs 115 receiving the ECN feedback may estimate and/or predict future rate changes, and such information may be signaled to a corresponding RAN 225 (e.g., to a network entity 105).

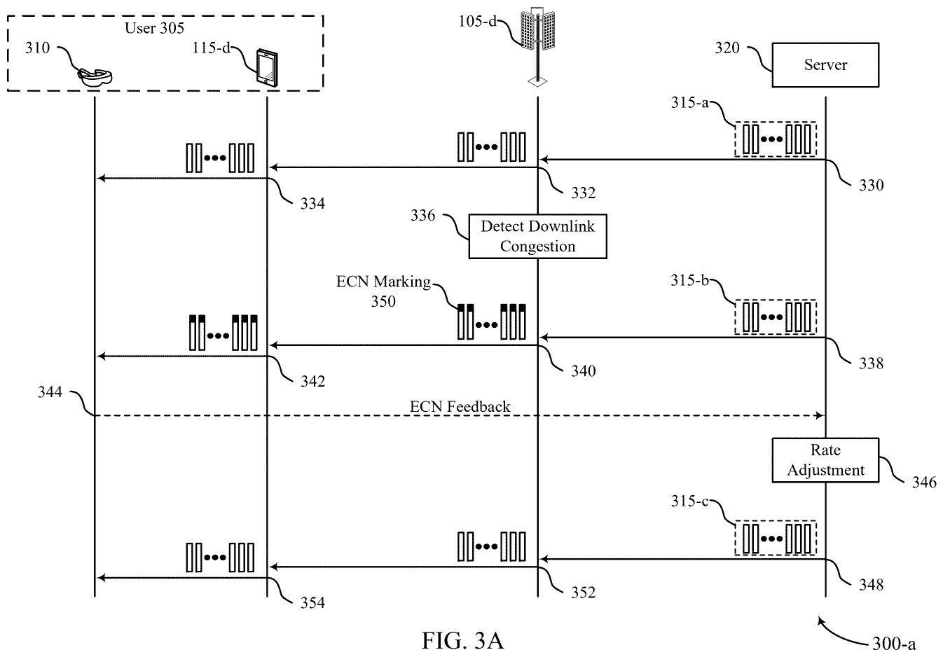

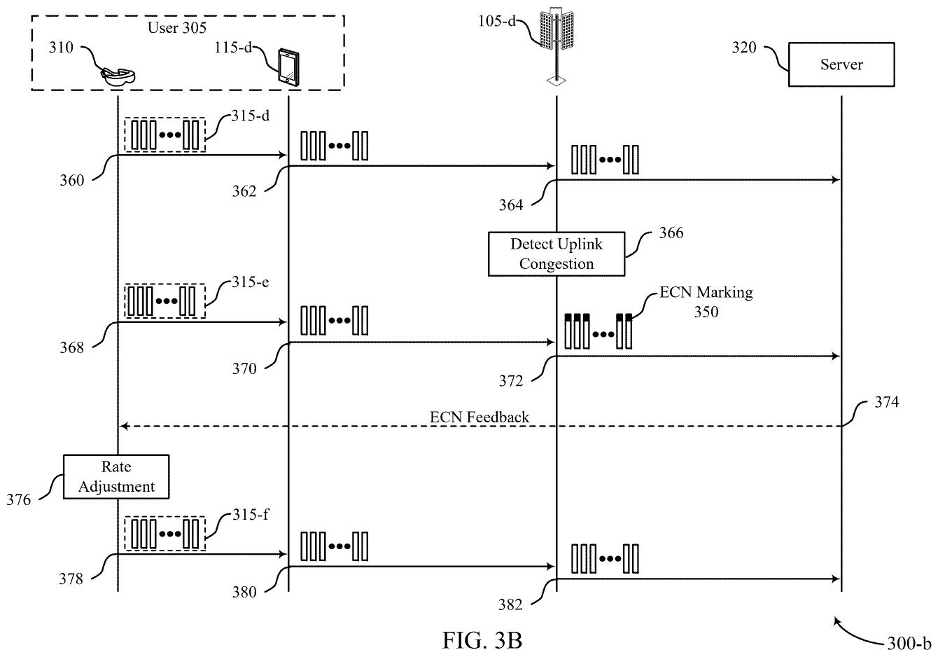

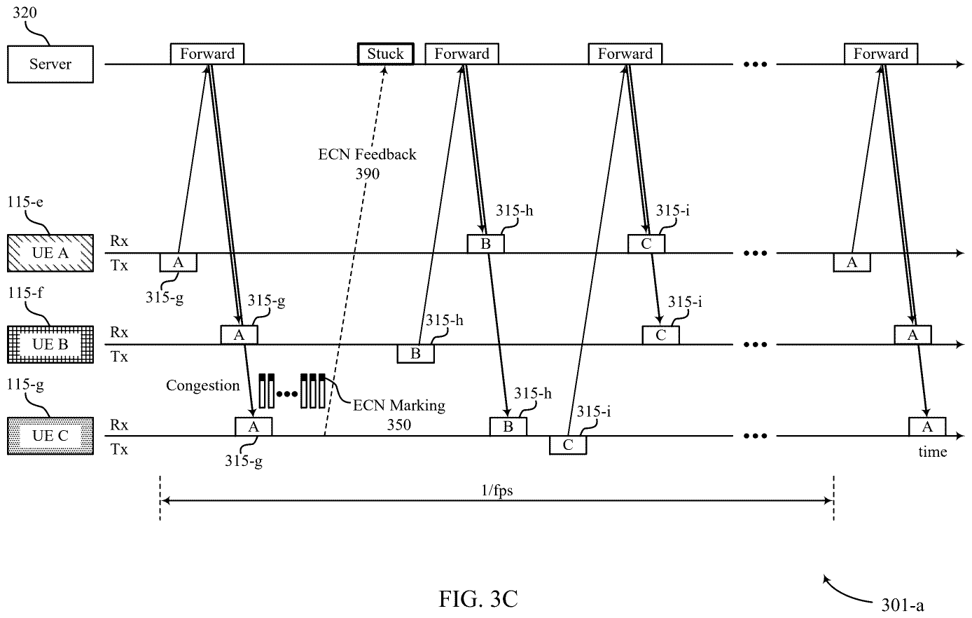

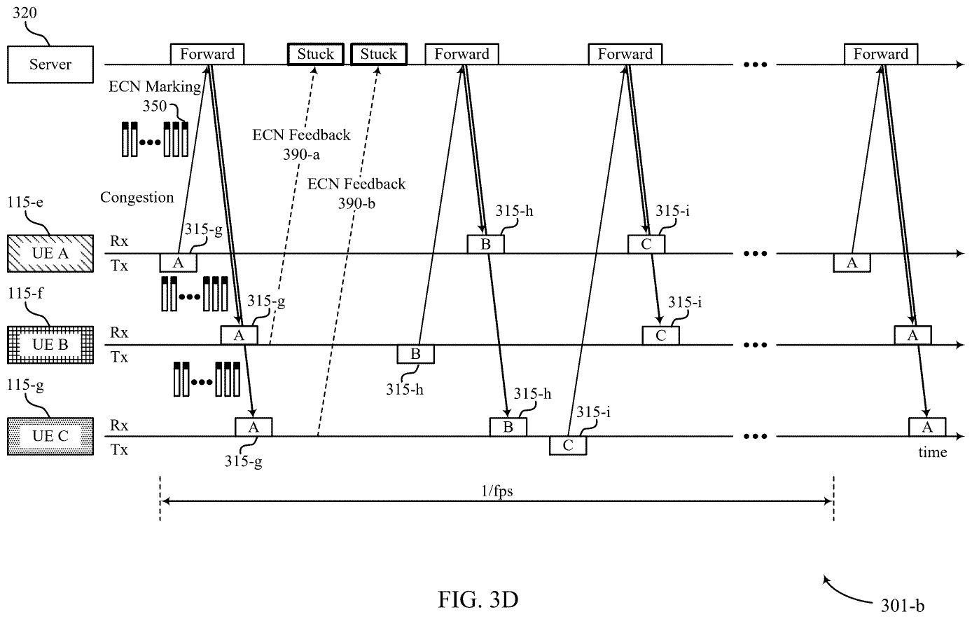

FIGS. 3A, 3B, 3C, and 3D show examples of a process flow 300-a, a process flow 300-b, a signaling diagram 301-a, and a signaling diagram 301-b, respectively, that support congestion handling for holographic communications in accordance with one or more aspects of the present disclosure. The process flow 300-a, the process flow 300-b, the signaling diagram 301-a, and the signaling diagram 301-b may each implement or be implemented by aspects of the wireless communications system 100 and the wireless communications system 200. For example, the process flow 300-a and the process flow 300-b may illustrate the transmission and reception of one or more packets 315 by one or more wireless communication devices associated with a user 305 (e.g., a UE 115-d and/or one or more peripheral devices 310) that support holographic communications. Additionally, the process flows 300-a and 300-b include a network entity 105-d that may be an example of the network entities 105 described with reference to FIGS. 1 and 2. Similarly, the signaling diagram 301-a and the signaling diagram 301-b may illustrate the transmission and reception of sets of packets 315 by one or more wireless communication devices associated with respective users 305 (e.g., a UE 115-e, a UE 115-f, and a UE 115-g). The process flow 300-a, the process flow 300-b, the signaling diagram 301-a, and the signaling diagram 301-b may each include an application server 320, which may be an example of the application server 220 described with reference to FIG. 2. In some aspects, the process flow 300-a, the process flow 300-b, the signaling diagram 301-a, and the signaling diagram 301-b may each support various techniques described herein for enabling ECN feedback to be provided to a wireless communication device for holographic communications.

The packets 315 communicated by each UE 115 may, additionally, or alternatively, be transmitted and/or received by one or more peripheral devices, which may be examples of the corresponding devices described with reference to FIGS. 1 and 2. As an example, a UE 115 may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and receive) signaling with the application server 320 via one or more network entities (such as a network entity 105 described with reference to FIGS. 1 and 2). For example, each UE 115 depicted in the signaling diagrams 301-a and 301-b may transmit and receive packets 315 via at least one network entity 105, where the at least one network entity 105 may be used for communicating the packets 315 between the application server 320 and each UE 115 of a set of multiple UEs 115 (e.g., UE 115-e, UE 115-f, UE 115-g, and so forth). Additional UEs 115 (not shown) may likewise exchange set of packets 315 via the application server 320, as a holographic communications session may include multiple users, and the quantity of UEs 115 (and users) shown in the examples provided herein should not be considered limiting to the scope of the claims or the disclosure.

The process flows 300-a and 300-b may each illustrate examples of techniques with which one or more ECN markings 350 are included in one or more packets 315 of a traffic flow. ECN techniques may enable the reporting of congestion conditions to an application client, for example, via the user plane, which may facilitate rate adaptation at the application layer. In some cases, a network entity 105-d associated with a RAN (e.g., an NG-RAN) may be responsible for detecting congestion, and the RAN or the UPF may mark packets 315 with an ECN marking 350. For example, the network entity 105-d may detect congestion and perform ECN marking for uplink and downlink in an IP layer for the received packets. The network entity 105-d may send the packets to the UE 115-d (e.g., for downlink) and UPF (e.g., for uplink). Alternatively, the network entity 105-d may detect the congestion for an uplink/downlink flow and indicate the latest congestion information to the UPF via a congestion report. Based on the received congestion report, the UPF may perform ECN marking for uplink and downlink in an IP layer for the received packets. It is noted that, while some examples provided herein describe congestion detected by a network entity 105, one or more aspects of the techniques described herein may also apply to cases where congestion is detected or identified by one or more other devices and/or nodes (e.g., congestion may be detected wherever it occurs). As such, the examples provided herein should not be considered limiting to the scope of the claims or the disclosure.

An example of downlink ECN marking techniques is shown by the process flow 300-a of FIG. 3A. For example, at 330, the application server 320 may output a set of packets 315-a of a traffic flow to the network entity 105-d. Accordingly, the network entity 105-d may obtain the set of packets 315-a and, at 332, the network entity 105-d may output the set of packets 315-a to a user 305 (e.g., to one or more wireless communication devices of the user 305 including, for example, a UE 115-d and/or one or more peripheral devices 310). In some cases, the UE 115-d may receive the set of packets 315-a and, at 334, may transmit the set of packets to the one or more devices 310.

At 336, the network entity 105-d may detect congestion (e.g., congestion causing delays in packet transmission and/or delivery, congestion resulting in packet loss, or the like) associated with the transmission of the first set of packets 315-a. In such cases, after the application server outputs another set of packets 315-b at 338, the network entity 105-d may include (e.g., add) one or more ECN markings 350 to the received set of packets 315-b. For example, at least one packet of the set of packets 315-b may include an ECN marking 350. At 340, the network entity 105-d may output the set of packets 315-b to the UE 115-d, where the set of packets 315-b received by the UE 115-d may include the ECN marking 350. The UE 115-d may transmit the set of packets 315-b having the ECN marking 350 to the one or more devices 310 (e.g., to an application client of the one or more devices 310) at 342.

The one or more devices 310 may identify the ECN marking 350 included with the received set of packets 315-b and, at 344, the one or more devices 310 may transmit (e.g., an application client of the one or more devices 310 may output) ECN feedback to the application server 320. In some cases, the ECN feedback may include feedback to the application server 320 (e.g., the source of the set of packets 315-b) about congestion and packet loss of a traffic flow corresponding to the set of packets 315-b. The ECN feedback may be reported to the application server 320, for example, via out-of-band signaling (e.g., using a channel that is different than a channel used for communicating the packets 315).

The application server 320 may obtain the ECN feedback at 344, and the application server 320 may perform rate adjustment (e.g., modifying a data rate) at 346, which may be based on the ECN feedback (e.g., based on information about the downlink congestion and/or packet loss for the corresponding flow). The modified data rate may be used to alleviate the downlink congestion identified by the network entity 105-d.

At 348, the application server 320 may output a set of packets 315-c using the modified data rate. The set of packets 315-c may be obtained by the network entity 105-d and output to the UE 115-d at 352. The UE 115-d may receive the set of packets 315-c and transmit the set of packets 315-c to the one or more devices 310 at 354.

Further, an illustrative example of uplink ECN marking techniques is shown by the process flow 300-b of FIG. 3B. Here, at 360, the one or more device 310 may transmit (e.g., an application client of the one or more devices 310 may output) a set of packets 315-d to the UE 115-d. At 362, the UE 115-d may transmit the set of packets 315-d to the network entity 105-d and, at 364, the network entity may output the set of packets 315-d to the application server 320.

Based on the set of packets 315-d received in the uplink at 362, the network entity 105-d may detect congestion associated with the set of packets 315-d at 366. As such, after the one or more devices 310 transmit a next set of packets 315-e to the UE 115-d at 368, and when the UE 115-d transmits the set of packets 315-e to the network entity 105-d at 370, the network entity 105-d may include one or more ECN markings 350 with the received set of packets 315-e (e.g., based on the detected congestion). For example, at least one packet of the set of packets 315-e may include the ECN marking 350. At 372, the network entity 105-d may output the set of packets 315-e including the ECN marking 350 to the application server 320.

At 372, the application server 320 may obtain the set of packets 315-e including the ECN marking 350, and the application server 320 may, at 374, transmit ECN feedback to the one or more devices 310 (e.g., to the application client of the one or more devices 310). In some examples, the application server 320 may report the ECN feedback to the application client via out-of-band signaling (e.g., via one or more channels different from channels used for the holographic communications).

The one or more devices 310 may receive (e.g., the application client of the one or more devices 310 may obtain) the ECN feedback at 374, and the one or more devices 310 may perform rate adjustment (e.g., modifying a data rate) at 376 based on the ECN feedback. The modified data rate may be used to alleviate the uplink congestion identified by the network entity 105-d.

At 378, the one or more devices 310 may transmit, to the UE 115-d, a set of packets 315-f using the modified data rate. The set of packets 315-f may be transmitted from the UE 115-d to the network entity 105-d at 380, and at 382, the network entity 105-d may output the set of packets 315-f to the application server 320.

However, some ECN techniques (e.g., for uplink congestion and downlink congestion) may be limited when applied to holographic communications (e.g., in systems using an SFU architecture). For instance, in the case of downlink congestion, downlink rate adaptation is based on ECN feedback received by the application server 320 (e.g., the ECN feedback at 344, as described with reference to FIG. 3A). From this ECN feedback, the application server 320 may modify (e.g., reduces or increases) the data rate. With holographic communications (e.g., implementing the SFU architecture), however, the application server 320 may not be the source of the data (e.g., a set of packets affected by congestion), and the application server 320 may therefore be unable to implement any modification of the data rate. Instead, one or more UEs 115 and/or devices 310 (e.g., an application client of the UE 115 and/or devices 310) may be the source (e.g., transmitter, originator) of the packets, and the application server 320 may only forward the packets transmitted from one client to the other clients. As a result, the ECN feedback sent to the application server 320 may not reach the source UEs 115 and/or devices for data rate modification.

Such issues are shown in the signaling diagram 301-a, where ECN feedback associated with signaling from one or more UEs 115 (e.g., corresponding to respective users) may fail to reach a device that may modify a data rate. The signaling diagram 301-a may represent signaling in a wireless communications system that supports holographic communications (such as the wireless communications system 100 and the wireless communications system 200 described with reference to FIGS. 1 and 2, respectively), which may implement the SFU architecture. Here, one or more UEs 115 may exchange signaling (e.g., sets of packets 315) for the holographic communications, where the sets of packets 315 are transmitted to the application server 320, which forwards the packets 315 to each of the other UEs 115. Accordingly, after reception of a set of packets 315 from a UE 115 (e.g., user i), the application server 320 may send the received frame to all other UEs 115 (e.g., users j). In some aspects, the application server 320 may send the packets 315 to the other UEs 115 immediately (e.g., without delay, with minimal delay, within a threshold duration). Further, in a holographic communications session that includes N users (e.g., N UEs 115), each user may receive N−1 packets 315 from other users every 1/fps.

In some examples, a first UE 115-e (e.g., UE A) may transmit a first set of packets 315-g to the application server 320, which may forward the first set of packets to the second UE 115-f (e.g., UE B), and the third UE 115-g (e.g., UE C). However, the transmission of the first set of packets 315-g to the third UE 115-g may be affected by congestion (such as congestion detected by a network entity 105 or another network node). As a result, the first set of packets 315-g may have an ECN marking 350 applied (e.g., included in at least one packet of the set of packets 315-g) before they are received by the third UE 115-g.

The UE 115-g may accordingly identify the ECN marking 350 and transmit a feedback message including ECN feedback 390, which may be transmitted via out-of-band signaling to the application server 320. The ECN feedback, however, may become “stuck” at the application server 320, as the application server 320 is not the same entity that transmitted the set of packets 315-g, and conventional ECN techniques may not enable the application server 320 to send or forward the ECN feedback to another device (such as the source of the set of packets 315-g, the UE 115-e). For example, the UE 115-f may transmit a second set of packets 315-h to the application server 320, which may forward the second set of packets 315-h to the UE 115-e and to the UE 115-g. But the application server may be unable to notify the UE 115-e of the downlink congestion identified by the UE 115-g for the set of packets transmitted by the UE 115-e (e.g., based on the ECN marking 350). Similarly, in accordance with conventional ECN techniques, when the UE 115-g transmits a third set of packets 315-i for the holographic communications, the ECN feedback 390 may remain “stuck” at (e.g., may not be forwarded by) the application server 320. Accordingly, the ECN feedback 390 may not be able to reach a transmitting UE 115 (e.g., a transmitting application client of the UE 115), possibly allowing congestion to go unaddressed in the system, which may affect the quality of the holographic communications.

Similar issues may occur for uplink congestion detected for sets of packets sent to the application server 320 for holographic communications. That is, in convention ECN techniques, the ECN feedback in response to uplink ECN marking 350 may be output by the application server 320 to an application client (such as the ECN feedback transmitted at 374 of FIG. 3B), and the application client may modify (e.g., reduce or increase) the data rate. But in accordance with holographic communications (e.g., using the SFU architecture), there may not be one receiving application running in a server. Instead, there may be several receiving applications, each of them running in a respective application client (e.g., at different wireless communication devices, such as the UE 115 and/or one or more devices 310). Each of the receiving application clients may issue an ECN feedback message, which may get “stuck” at (e.g., not forwarded by) the application server 320.

For instance, and as illustrated by the signaling diagram 301-b, the UE 115-e may transmit the first set of packets 315-g to the application server 320 for forwarding to each other UE 115 (to the UE 115-f and the UE 115-g). However, congestion may be detected for the flow associated with the first set of packets 315-g (e.g., by a network entity 105), which may result in one or more ECN markings 350 being applied to the set of packets 315-g (e.g., at least one packet of the set of packets 315-g may include an ECN marking 350).

In such cases, when the application server 320 forwards the set of packets 315-g including the one or more ECN markings 350, one or both of the UE 115-f and the UE 115-g may identify the ECN marking 350 and may transmit ECN feedback 390. For example, the UE 115-f may transmit the ECN feedback 390-a to the application server 320 (e.g., via out-of-band signaling), and the UE 115-g may transmit the ECN feedback 390-b to the application server 320 (e.g., via out-of-band signaling). The ECN feedback 390-a and the ECN feedback 390-b may become “stuck” at the application server 320 because the application server 320 may not be the source of the set of packets 315-g, and conventional ECN techniques may not enable the application server 320 to forward the ECN feedback 390 to another device. As similarly described above, the UE 115-f may transmit a second set of packets 315-h to the application server 320, which may forward the second set of packets 315-h to the UE 115-e and to the UE 115-g. But the application server 320 may be unable to notify the UE 115-e of the downlink congestion experienced by the UE 115-g for the set of packets transmitted by the UE 115-e. Similarly, in accordance with conventional ECN techniques, when the UE 115-g transmits a third set of packets 315-i for the holographic communications, the ECN feedback 390 may remain “stuck” at (e.g., may not be forwarded by) the application server 320. Thus, ECN feedback 390 may not be able to reach a transmitting UE 115 (e.g., a source application client of the UE 115), potentially allowing congestion to go unmitigated in the system, which may affect the quality of the holographic communications and affect user experience.

Thus, in accordance with one or more techniques described herein, ECN feedback for holographic communications may be routed to a device that transmits (e.g., is the source of) packets affected by congestion. For example, the UE 115-f may receive the first set of packets 315-g that include at least one packet having an ECN marking 350 (e.g., within a header of the at least one packet). The UE 115-g may transmit a feedback message to the application server 320, where the feedback message may include ECN feedback 390 and an ID corresponding to a UE 115 that is the source of the at least one packet having the ECN marking (e.g., an ID of the UE 115-e, in this example). The application server 320 may provide the ECN feedback to the source UE 115-e based on the ID included in the feedback message. The source UE 115-e may modify a data rate (e.g., reduce a data rate) associated with the traffic flow in accordance with the ECN feedback received from the application server. That is, the additional information (e.g., the ID) included in the feedback message (e.g., with the ECN feedback 390) may enable the application server 320 to forward the ECN feedback to an appropriate UE 115 (and corresponding application client) that may modify the data rate.

In some aspects, the feedback message may include IDs of one or more other UEs 115, and the application server 320 may accordingly send the feedback message to multiple UEs 115, which may either ignore the ECN feedback (e.g., if the ID included in the feedback message is different from an ID of the UE 115) or may perform rate adaptation (e.g., if the ID included in the feedback message is the same as ID of the UE 115). Such techniques may therefore enable congestion to be mitigated for holographic communications, for example, in systems that implement an SFU architecture.

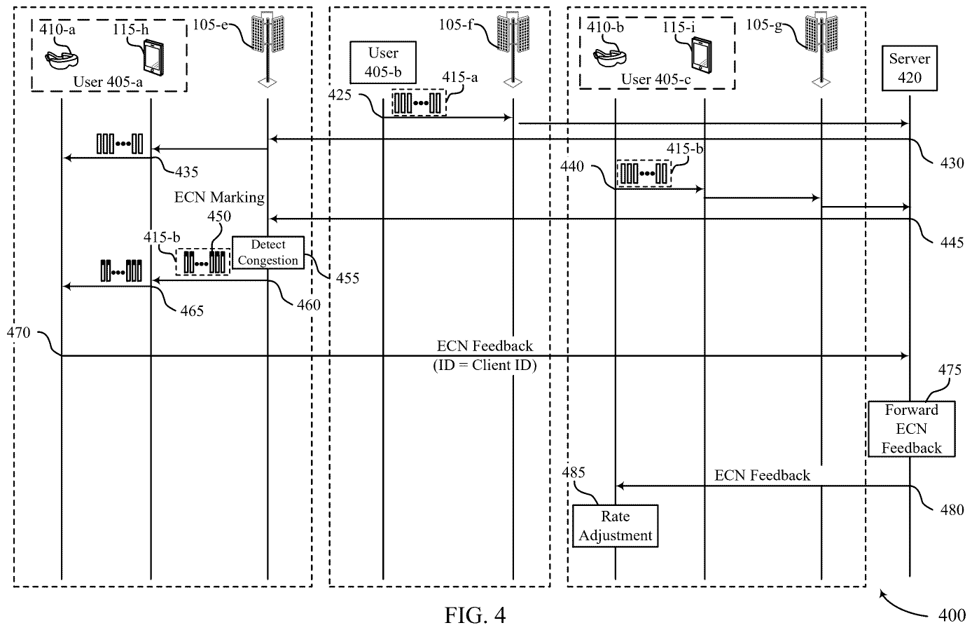

FIG. 4 shows an example of a process flow 400 that supports congestion handling for holographic communications in accordance with one or more aspects of the present disclosure. In some examples, the process flow 400 may implement or be implemented by aspects of the wireless communications system 100, the wireless communications system 200, the process flow 300-a, the process flow 300-b, the signaling diagram 301-a, the signaling diagram 301-b, or any combination thereof. For example, the process flow 400 may include multiple users 405 (e.g., a first user 405-a, a second user 405-b, a third user 405-c), where each user may be associated with one or more wireless communication devices that support holographic communications. For instance, the first user 405-a may be associated with a UE 115-h and/or one or more devices 410-a, which may be examples of the corresponding devices described herein (such as the UEs 115 and one or more devices 210 described with reference to FIG. 2). Similarly, the second user 405-b and the third user 405-c may be associated with one or more wireless communication devices, such as a UE 115-i and/or one or more devices 410-b for the third user 405-c. Although not shown for the second user 405-b, it is implicit that data transmission and reception for holographic communications for the second user 405-b are performed by at least one wireless communication device (e.g., a UE 115, a peripheral device 410, or the like).

The process flow 400 further includes one or more network entities 105, including a network entity 105-e, a network entity 105-f, and a network entity 105-g, which may each be an example of the corresponding network entities 105 described with reference to FIGS. 1 and 2. The process flow further includes an application server 420, which may be an example of the application server 220 and the application server 320 described with reference to FIGS. 2, 3A, 3B, 3C, and 3D. The application server 420 may be associated with an SFU architecture that is utilized for holographic communications.

In the following description of the process flow 400, the operations between the UEs 115, the network entities 105, and the application server 420 may be communicated in a different order than the example order shown, or the operations performed by one or more of the UEs 115, the network entities 105, and the application server 420 may be performed in different orders or at different times. Some operations may also be omitted from the process flow 400, and other operations may be added to the process flow 400. Further, as described herein, aspects of the functions performed by one or more of the UEs 115 may additionally, or alternatively, be performed by one or more other wireless communication devices (e.g., one or more peripheral devices).

The process flow 400 may illustrate one or more techniques for forwarding ECN feedback to a source wireless device to perform rate adjustment based on detected congestion. Such techniques may be referred to as, for example, client-to-server-to-client signaling techniques, which may include one or more enhancements to out-of-band signaling used for ECN feedback. For example, after detection of an ECN marking in a downlink flow from a transmitting application client (e.g., an application client of the UE 115-i and/or the one or more devices 410-b), a receiving application client (e.g., an application client of the UE 115-h and/or the one or more devices 410-a) may transmit ECN feedback to the application server 420, which forwards the ECN feedback to the transmitting application client (e.g., the application client of the UE 115-i and/or the one or more devices 410-b). In such cases, out-of-band signaling used for the ECN feedback between an application client and the application server 420 is enhanced to carry an ID of the transmitting application client.

For example, at 425, one or more devices associated with the second user 405-b may transmit a set of packets 415-a associated with a traffic flow, which may be transmitted via the network entity 105-f to the application server 420.

At 430, the application server 420 may forward the set of packets 415-a to wireless communication devices associated with the first user 405-a (e.g., to the UE 115-h and/or the one or more devices 410-a) via the network entity 105-e. In such cases, the set of packets 415-a (and a traffic flow associated with the set of packets 415-a) may not be affected by congestion. The set of packets 415-a may be transmitted, at 435, from the UE 115-h to the one or more devices 410-a (e.g., to an application client of the one or more devices 410-a), which may render the data contained within the set of packets 415-a.

At 440, one or more devices associated with the third user 405-c may transmit a set of packets 415-b associated with a traffic flow, which may be transmitted via the network entity 105-g to the application server 420. For example, an application client of the one or more devices 410-b may originate the set of packets 415-b, and the one or more devices 410-b may transmit the set of packets 415-b to the UE 115-i, which may transmit the set of packets 415-b to the application server 420 via the network entity 105-g.

At 445, the application server 420 may output the set of packets 415-b to the wireless communication devices associated with the first user 405-a (e.g., to the UE 115-h and/or the one or more devices 410-a) via the network entity 105-e. In some cases, however, there may be congestion associated with the downlink transmission of the set of packets 415-b, which may result in at least one packet of the set of packets 415-b having an ECN marking 450 included (e.g., in a header of the packet) to notify a receiving device (e.g., the UE 115-h and/or the one or more devices 410-a) of the associated congestion. As an example, the network entity 105-e may, at 455, detect congestion associated with the packets 415-b, and the network entity 105-e may perform an ECN marking procedure to include the ECN marking 450 with one or more of the packets of the set of packets 415-b.

At 460, the network entity 105-e may output the set of packets 415-b including the ECN marking 450 to the UE 115-h. At 465, the UE 115-h may transmit the set of packets 415-b including the ECN marking 450 to the one or more devices 410-a (e.g., to an application client of the one or more devices 410-a).

The application client of the one or more devices 410-a may identify the ECN marking 450 and, at 470, the one or more devices 410-a may transmit (e.g., the application client of the one or more devices 410-a may output) a feedback message to the application server 420. The feedback message may include ECN feedback (e.g., congestion information corresponding to the traffic flow of the set of packets 415-b (such as packet loss or other information)), and the feedback message may further include an ID (or one or more IDs) of the one or more devices 410-b (e.g., a wireless communication device that is a source of the set of packets 415-b). As described herein, the feedback message transmitted at 470 may be sent via out-of-band signaling to the application server 420.

The application server 420 may receive the feedback message including the ECN feedback and the ID of the one or more devices 410-b and, at 475, the application server 420 may forward the ECN feedback to the one or more devices 410-b based on the ID included in the feedback message. For instance, at 480, the application server 420 may output the ECN feedback to the one or more devices 410-b (e.g., to the application client of the one or more devices 410-b), which may be signaled via the network entity 105-g and/or the UE 115-i.

After receiving the ECN feedback at 480, the one or more devices 410-b may, at 485, modify a data rate associated with the traffic flow and in accordance with the congestion information provided by the ECN feedback. Accordingly, the modified data rate may be used to mitigate and/or eliminate the congestion detected for the traffic flow associated with the set of packets 415-b.

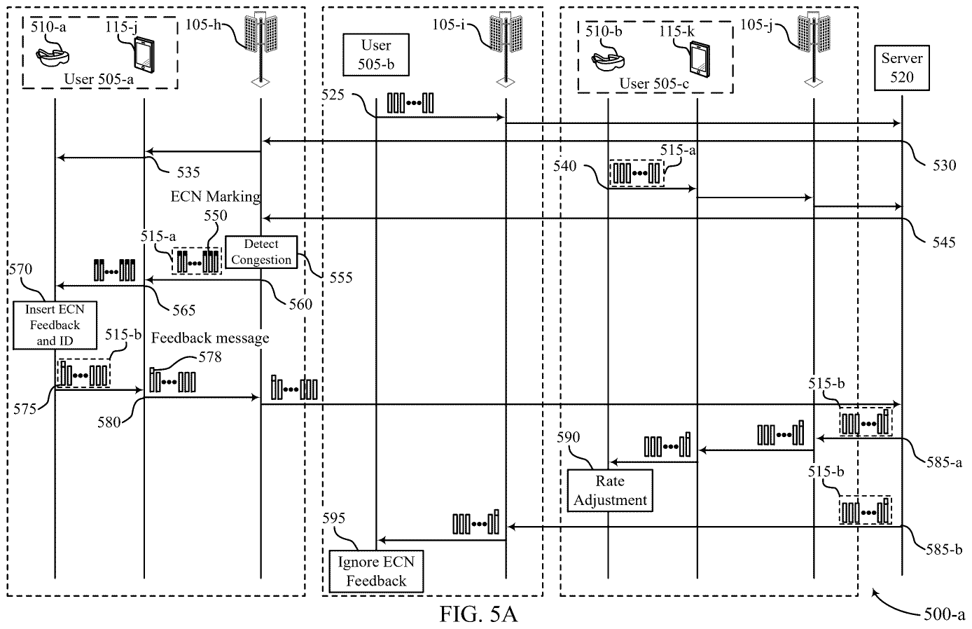

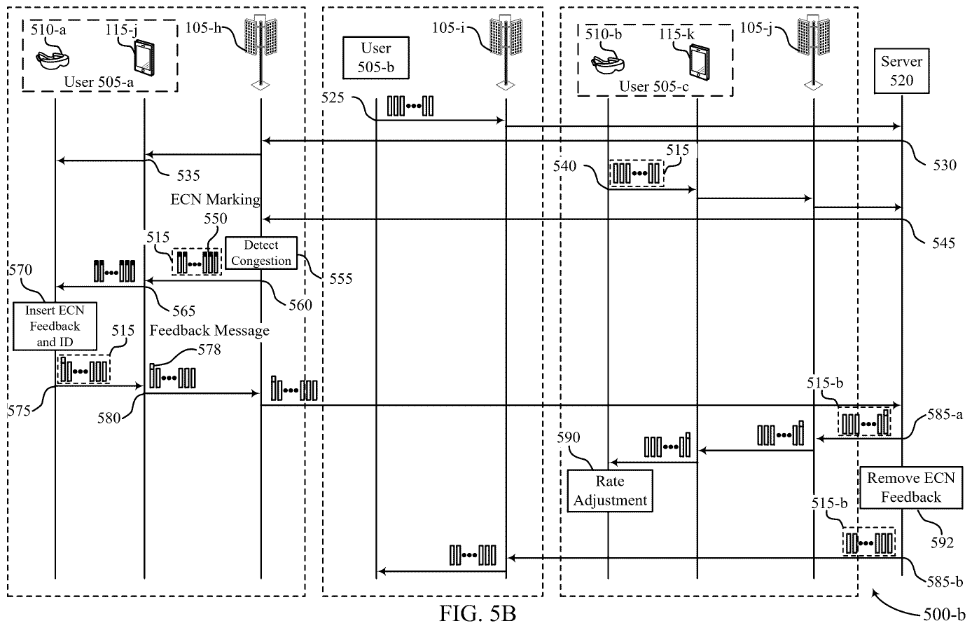

FIGS. 5A and 5B shows example of a process flow 500-a and a process flow 500-b, respectively, that support congestion handling for holographic communications in accordance with one or more aspects of the present disclosure. In some examples, the process flow 500-a and the process flow 500-b may implement or be implemented by aspects of the wireless communications system 100, the wireless communications system 200, the process flow 300-a, the process flow 300-b, the signaling diagram 301-a, the signaling diagram 301-b, the process flow 400, or any combination thereof. For example, the process flow 500-a and the process flow 500-b may include multiple users 505 (e.g., a first user 505-a, a second user 505-b, a third user 505-c), where each user may be associated with one or more wireless communication devices that support holographic communications. For example, the first user 505-a may be associated with a UE 115-j and/or one or more devices 510-a, which may be examples of the corresponding devices described herein (such as the UEs 115 and one or more devices 210 described with reference to FIG. 2). Similarly, the second user 505-b and the third user 505-c may be associated with one or more wireless communication devices, such as a UE 115-k and/or one or more devices 510-b for the third user 505-c. Although not shown for the second user 505-b, it is inherent that holographic communications associated with the second user 505-b are performed by at least one wireless communication device (e.g., a UE 115, a peripheral device 510, or the like).

The process flow 500-a and the process flow 500-b further include one or more network entities 105, including a network entity 105-h, a network entity 105-i, and a network entity 105-j, which may each be an example of the corresponding network entities 105 described with reference to FIGS. 1 and 2. The process flow further includes an application server 520, which may be an example of the application server 220 and the application server 320 described with reference to FIGS. 2, 3A, 3B, 3C, 3D, and 4. The application server 520 may be associated with an SFU architecture that is utilized for holographic communications.

In the following description of the process flow 500-a and the process flow 500-b, the operations between the UEs 115, the network entities 105, and the application server 520 may be communicated in a different order than the example order shown, or the operations performed by one or more of the UEs 115, the network entities 105, and the application server 520 may be performed in different orders or at different times. Some operations may also be omitted from the process flow 500-a and/or the process flow 500-b, and other operations may be added to the process flow 500-a and/or the process flow 500-b. Further, as described herein, aspects of the functions performed by one or more of the UEs 115 may additionally, or alternatively, be performed by one or more other wireless communication devices (e.g., one or more peripheral devices).

The process flow 500-a may illustrate one or more techniques for signaling ECN feedback via in-band signaling, which may enable the ECN feedback to be obtained by a wireless communication device that is the source of a set of packets 515 affected by congestion. Such techniques may be referred to as client-to-client signaling techniques, which may include the indication of ECN feedback via the user plane. For example, a receiving application client (e.g., an application client of a UE 115 and/or one or more devices 510 that receives a set of packets including an ECN marking) may transmit a feedback message including ECN feedback and a transmitting client ID through the User Plane. In some aspects, one or more header extensions (e.g., such as real-time transport protocol (RTP) header extensions) may be used to carry the ECN Feedback and client ID of the feedback message. Further, the receiving application client may transmit the ECN Feedback via one or more (e.g., any of the) IP packets of an uplink flow. In some cases, the application client(s) that receive the ECN feedback and whose ID does not match the client ID associated to that feedback may ignore the ECN feedback reported by the receiving application client.

For example, at 525, one or more devices associated with the second user 505-b may transmit (e.g., a transmitting application client of one or more devices and or UEs 115 may output) a set of packets associated with a traffic flow, which may be transmitted via a UE 115 and/or the network entity 105-i to the application server 520.

At 530, the application server 520 may forward the set of packets to wireless communication devices associated with the first user 505-a (e.g., to the UE 115-j and/or the one or more devices 510-a) via the network entity 105-h. In such cases, the set of packets (and a traffic flow associated with the set of packets) may not be affected by congestion. The set of packets may be transmitted, at 535, from the UE 115-j to the one or more devices 510-a (e.g., to an application client of the one or more devices 510-a), which may render the data contained within the set of packets.

At 540, one or more devices associated with the third user 505-c may transmit (e.g., a transmitting application client of the one or more devices 510-b may output) a set of packets 515-a associated with a traffic flow, which may be transmitted via the network entity 105-j to the application server 520. For example, an application client of the one or more devices 510-b may be the source of the set of packets 515-a, and the one or more devices 510-b may transmit the set of packets 515-a to the UE 115-k, which may transmit the set of packets 515-a to the application server 520 via the network entity 105-j.

At 545, the application server 520 may output the set of packets 515-a to the wireless communication devices associated with the first user 505-a (e.g., to the UE 115-j and/or the one or more devices 510-a) via the network entity 105-h. In some cases, however, there may be congestion associated with the downlink transmission of the set of packets 515-a, which may result in at least one packet of the set of packets 515-a having an ECN marking 550 added (e.g., in a header of the packet) to notify a receiving device (e.g., the UE 115-j and/or the one or more devices 510-a) of the associated congestion. As an example, the network entity 105-h may, at 555, detect congestion associated with the set of packets 515-a, and the network entity 105-h may perform an ECN marking procedure to include the ECN marking 550 with one or more of the packets of the set of packets 515-a.

At 560, the network entity 105-h may output the set of packets 515-a including the ECN marking 550 to the UE 115-j. At 565, the UE 115-j may transmit the set of packets 515-a including the ECN marking 550 to the one or more devices 510-a (e.g., to an application client of the one or more devices 510-a).

The application client of the one or more devices 510-a may identify the ECN marking 550 and, at 570, the one or more devices 510-a (e.g., the application client of the one or more devices 510-a) may insert ECN feedback and an ID (or one or more IDs) of the one or more devices 510-b and/or application client of the one or more devices 510-b (e.g., associated with a wireless communication device that is a source of the set of packets 515-a). Here, the ECN feedback may be based on the ECN marking 550 included with the set of packets 515-a, and may include, for example, congestion information (such as packet loss or other information corresponding to the congested traffic flow).

At 575, the one or more devices 510-a may transmit (e.g., the application client of the one or more devices 510-a may output) a set of packets 515-b as part of the holographic communications (e.g., via the user plane, via in-band signaling). The set of packets 515-b include a feedback message 578 that provides an indication of the ECN feedback and the ID of the transmitting device, which may be included within one or more headers of the set of packets 515-b. That is, after detecting an ECN marking 550 in set of packets 515-a associated with a downlink flow from a transmitting application client (e.g., an application client of the one or more devices 510-b), the receiving application client (e.g., the application client of the one or more devices 510-a) may transmit the ECN Feedback to the transmitting application client via the data (e.g., video data) that the receiving application client is transmitting. As such, the set of packets 515-b may be received by the UE 115-j at 575 and, at 580, the UE 115-j may transmit the set of packets 515-b to the application server 520 (e.g., via the network entity 105-h), where the set of packets may include the feedback message 578 when received by the application server 520.

Because the set of packets 515-b may be received via the user plane as part of the holographic communications, the application server 520 (e.g., associated with an SFU) may immediately forward the set of packets 515-b to other wireless communication devices included in the holographic communications session. For example, at 585-a, the application server 520 may output the set of packets 515-b to the third user 505-c (e.g., to the one or more devices 510-b of the third user 505-c, which may be sent via the network entity 105-j and/or the UE 115-k) and the application server 520 may output the set of packets 515-b at 585-b, to the device(s) of the second user 505-b. At 585-a, the packets forwarded to the third user 505-c may include the feedback message 578 that indicates the ECN feedback for the set of packets 515-a affected by the congestion. As a result, at 590, the one or more devices 510-b, after receiving the ECN feedback included in the set of packets 515-b, may modify a data rate associated with the traffic flow and in accordance with the congestion information provided by the ECN feedback. Accordingly, the modified data rate may be used to mitigate and/or eliminate the congestion detected for the traffic flow associated with the set of packets 515-a.

Further, at 585-b, the one or more devices associated with the second user 505-b may receive the ECN feedback included in the set of packets 515-b and, at 595, may ignore the ECN feedback based on the ID included in the feedback message. That is, one or more devices (and/or one or more application clients) may determine that the ID associated with the received ECN feedback is not associated with the devices of the second user 505-b. As such, the ECN feedback may be ignored because the corresponding ECN markings 550 were associated with congestion affecting another traffic flow.

Additionally, or alternatively, the application server 520 may inspect IP packets that include feedback messages and my remove the ECN feedback from one or more IP packets that may otherwise be forwarded to application clients whose ID do not match the client ID associated with the ECN feedback. For example, and as illustrated by the process flow 500-b of FIG. 5B, the application server may perform one or more operations to remove information from a received set of packets 515-b before forwarding the set of packets 515-b to some wireless communication devices. In the process flow 500-b of FIG. 5B, the features at 525 through 580 may be the same as the corresponding steps described with reference to the process flow 500-a, and are not repeated again for the sake of brevity.

In some examples, at 585-a of FIG. 5B, the application server 520 may output the set of packets 515-b to the third user 505-c and, at 590 of FIG. 5B, a data rate may be modified by the one or more devices 510-b in accordance with the ECN feedback included in the set of packets 515-b. At 592 of FIG. 5B, however, the application server may remove the ECN feedback and/or the ID from the set of packets 515-b. Accordingly, at 585-b of FIG. 5B, the application server 520 may output (e.g., forward) the set of packets 515-b to the devices of the second user 505-b (e.g., without the ECN feedback), which may be rendered by the devices of the second user 505-b as part of the holographic communications. In such cases, the devices of the second user 505-b may not need to perform any additional processes to determine whether the ECN feedback is associated with a traffic flow of the second user 505-b.

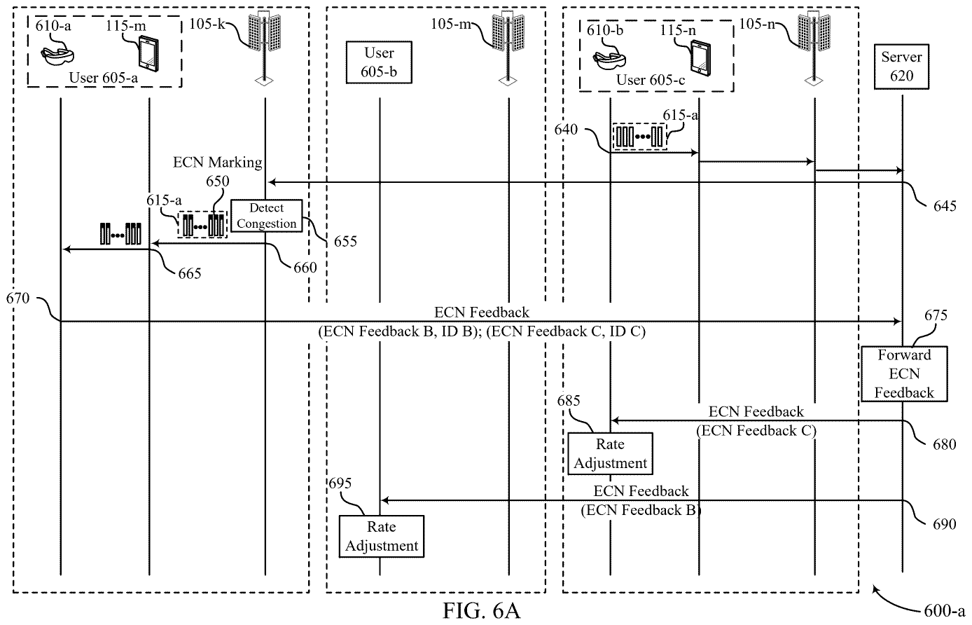

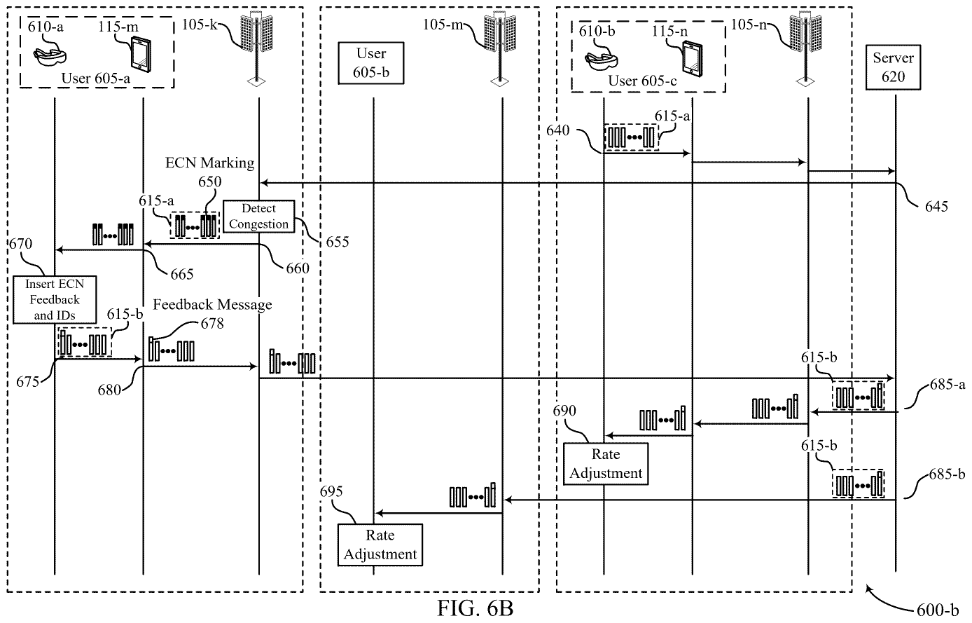

FIGS. 6A and 6B show examples of a process flow 600-a and a process flow 600-b, respectively, that support congestion handling for holographic communications in accordance with one or more aspects of the present disclosure. In some examples, the process flow 600-a and the process flow 600-b may implement or be implemented by aspects of the wireless communications system 100, the wireless communications system 200, the process flow 300-a, the process flow 300-b, the signaling diagram 301-a, the signaling diagram 301-b, the process flow 400, the process flow 500-a, the process flow 500-b, or any combination thereof. For example, the process flow 600-a and the process flow 600-b may include multiple users 605 (e.g., a first user 605-a, a second user 605-b, a third user 605-c), where each user may be associated with one or more wireless communication devices that support holographic communications. For example, the first user 605-a may be associated with a UE 115-m and/or one or more devices 610-a, which may be examples of the corresponding devices described herein (such as the UEs 115 and one or more devices 210 described with reference to FIG. 2). Similarly, the second user 605-b and the third user 605-c may be associated with one or more wireless communication devices, such as a UE 115-n and/or one or more devices 610-b for the third user 605-c. Although not shown for the second user 605-b, it is inherent that holographic communications associated with the second user 605-b are performed by at least one wireless communication device (e.g., a UE 115, a peripheral device 610, or the like).

The process flow 600-a and the process flow 600-b further include one or more network entities 105, including a network entity 105-k, a network entity 105-m, and a network entity 105-n, which may each be an example of the corresponding network entities 105 described with reference to FIGS. 1 and 2. The process flow further includes an application server 620, which may be an example of the application server 220 and the application server 320 described with reference to FIGS. 2, 3A, 3B, 3C, 3D, 4, 5A, and 5B. The application server 620 may be associated with an SFU architecture that is utilized for holographic communications.

In the following description of the process flow 600-a and the process flow 600-b, the operations between the UEs 115, the network entities 105, and the application server 620 may be communicated in a different order than the example order shown, or the operations performed by one or more of the UEs 115, the network entities 105, and the application server 620 may be performed in different orders or at different times. Some operations may also be omitted from the process flow 600-a and/or the process flow 600-b, and other operations may be added to the process flow 600-a and/or the process flow 600-b. Further, as described herein, aspects of the functions performed by one or more of the UEs 115 may additionally, or alternatively, be performed by one or more other wireless communication devices (e.g., one or more peripheral devices).

The process flow 600-a may illustrate one or more techniques for signaling ECN feedback to multiple application clients, which may enable the ECN feedback to be obtained by multiple wireless communication devices to perform rate adjustment based on at least some packets 615 for holographic communications being affected by congestion. Such techniques may be referred to as client-to-multiple clients signaling techniques, which may include the indication of ECN feedback via out-of-band signaling and/or the user plane to multiple wireless communication devices included in holographic communications. For example, even though a receiving application client (e.g., an application client associated with the one or more devices 610-a) may detect congestion associated with one flow (e.g., a traffic flow associated with a set of packets 615-a output by the one or more devices 610-b), the receiving application client may transmit a feedback message with multiple ECN feedbacks to multiple transmitting application client IDs (e.g., such as for application clients associated with respective devices the second user 605-b and the third user 605-c). In such examples, the ECN feedback provided to multiple devices and/or application clients may enable multiple data rate modifications for devices included in a holographic communications session (instead of one device only modifying a data rate).

In the process flow 600-a, the features at 640, 645, 655, 660, and 665 may be similar to the features described herein, for example, with reference to the features at 540, 545, 555, 560, and 565 of FIG. 5A, and such features are not repeated here for the sake of brevity. Generally, the one or more devices 610-a of the first user 605-a may receive a set of packets 615-a that include one or more ECN markings 650 based on congestion detected by the network entity 105-k.

The application client of the one or more devices 610-a may identify the ECN marking 650 and, at 670, the one or more devices 610-a may transmit (e.g., the application client of the one or more devices 610-a may output) a feedback message to the application server 620. The feedback message may include multiple ECN feedbacks (e.g., congestion information corresponding to the traffic flow of the set of packets 615-a (such as packet loss or other information)), and the feedback message may further include multiple IDs corresponding to the second user 605-b (e.g., one or more devices of the second user 605-b) and corresponding to the third user 605-c (the one or more devices 610-b and/or the UE 115-n). In such cases, the feedback message may include ECN feedback associated with a traffic flow of the second user 605-b and ECN feedback a traffic flow of the third user 605-c. That is, a receiving application client of the one or more devices 610-a may transmit multiple ECN feedbacks (e.g., multiple ECN feedback messages, multiple ECN feedback indications) and transmitting client IDs. In such cases, the IDs included in the feedback message may correspond to (e.g., may be linked to) the ECN feedback that is included in the feedback message. As such, a receiving device may be able to identify, using the ID and/or the ECN feedback, which device and/or application client to which the ECN feedback applies. The feedback message transmitted at 670 may be sent via out-of-band signaling to the application server 620.

In some aspects, the receiving application client of the one or more devices 610-a may include the multiple ECN feedbacks and the multiple IDs irrespective of the flows that are experiencing actual congestion. That is, the application client may indicate the IDs of some other devices associated with traffic flows that may not be experiencing congestion and provide ECN feedback information for those traffic flows in the feedback message.

In any case, at 675, the application server 620 may receive the feedback message including the ECN feedbacks and the IDs of the multiple devices and may forward the ECN feedback to the one or more devices 610-b and to one or more devices associated with the second user 605-b based on the multiple IDs included in the feedback message. For instance, at 680, the application server 620 may output the ECN feedback to the one or more devices 610-b (e.g., to the application client of the one or more devices 610-b), which may be signaled via the network entity 105-n and/or the UE 115-n.

In some examples, before forwarding the ECN feedback to the multiple users 605, the application server 620 may modify the ECN feedback and IDs included in the feedback message. For example, the feedback message may include a list, such as {ECN Feedback, client ID} for multiple application clients/IDs, and the application server may add or remove some entries from the list, which may modify which devices (and corresponding application clients) receive the ECN feedback that is forwarded by the application server 620.

After receiving the ECN feedback at 680, the one or more devices 610-b may, at 685, modify a data rate associated with the traffic flow and in accordance with the congestion information provided by the ECN feedback corresponding to the one or more devices 610-b. The modified data rate may be used to mitigate and/or eliminate the congestion detected for the traffic flow associated with the set of packets 615-a.

Further, at 690, the application server 620 may output the ECN feedback to one or more devices associated with the second user 605-b (e.g., to the application client of the one or more devices), which may be signaled via the network entity 105-m and/or a UE 115. After receiving the ECN feedback at 690, the one or more devices of the second user 605-b may modify a data rate associated with the traffic flow and in accordance with the congestion information provided by the ECN feedback corresponding to the one or more devices. That is, because congestion affecting one traffic flow (e.g., a traffic flow associated with the set of packets 615-a) may have a potential impact on other traffic flows, the data rate for packets of the second user 605-b may also be adjusted, for example, to preemptively resolve congestion affecting the second user 605-b.

Additionally, or alternatively, and as illustrated in the process flow 600-b of FIG. 6B, the feedback message including multiple ECN feedback and multiple IDs may be transmitted via in-band signaling (e.g., via the user plane). Here, the features of 640 through 665 of FIG. 6B may be the same as those described with reference to 640 through 665 of FIG. 6A and are not repeated again for the sake of brevity.

In FIG. 6B, the application client of the one or more devices 610-a may identify the ECN marking 650 and, at 670, the one or more devices 610-a (e.g., the application client of the one or more devices 610-a) may insert a feedback message 678 into a set of packets 615-b. The feedback message 678 may include multiple ECN feedbacks (e.g., congestion information (such as packet loss or other information)) and multiple IDs corresponding to, for example, the second user 605-b (e.g., one or more devices of the second user 605-b) and corresponding to the third user 605-c (the one or more devices 610-b and/or the UE 115-n). In such cases, the feedback message 678 may be transmitted to the application server 620 via the user plane as part of the set of packets 615-b from the one or more devices 610-a for holographic communications.

At 675 of FIG. 6B, the one or more devices 610-a may transmit (e.g., the application client of the one or more devices 610-a may output) a set of packets 615-b as part of the holographic communications (e.g., via the user plane, via in-band signaling). The set of packets 615-b may include the feedback message 678 that provides an indication of the respective ECN feedback and corresponding IDs for multiple transmitting devices (e.g., transmitting application clients), which may be included within one or more headers of the set of packets 615-b. That is, after detecting an ECN marking 650 in set of packets 615-a associated with a downlink flow from a transmitting application client (e.g., an application client of the one or more devices 610-b), the receiving application client (e.g., the application client of the one or more devices 610-a) may transmit the ECN feedback to multiple transmitting application clients via the data (e.g., video data) that the receiving application client is transmitting. As such, the set of packets 615-b may be received by the UE 115-m at 675 of FIG. 6B and, at 680 of FIG. 6B, the UE 115-m may transmit the set of packets 615-b to the application server 620 (e.g., via the network entity 105-k). The set of packets 615-b may include the feedback message 678 when received by the application server 620.

Because the set of packets 615-b may be received via the user plane as part of the holographic communications, the application server 620 may immediately forward the set of packets 615-b to other wireless communication devices included in the holographic communications session. For example, at 685-a of FIG. 6B, the application server 620 may output the set of packets 615-b to the third user 605-c (e.g., to the one or more devices 610-b of the third user 605-c, which may be sent via the network entity 105-n and/or the UE 115-n) and the application server 620 may output the set of packets 615-b at 685-b of FIG. 6B, to the device(s) of the second user 605-b. At 685-a and at 685-b of FIG. 6B, the packets 615-b forwarded to the third user 605-c and to the second user 605-b may include the feedback message 678 that indicates the respective ECN feedback for those users 605. As a result, at 690 of FIG. 6B, the one or more devices 610-b may, after receiving the ECN feedback included in the set of packets 615-b, modify a data rate associated with the traffic flow and in accordance with the congestion information provided by the corresponding ECN feedback. Accordingly, the modified data rate may be used to mitigate and/or eliminate the congestion detected for the traffic flow associated with the set of packets 615-a. Similarly, at 695 of FIG. 6B, the one or more devices associated with the second user 605-b may, after receiving the ECN feedback included in the set of packets 615-b, modify a data rate associated with a traffic flow and in accordance with the congestion information provided by the corresponding ECN feedback.

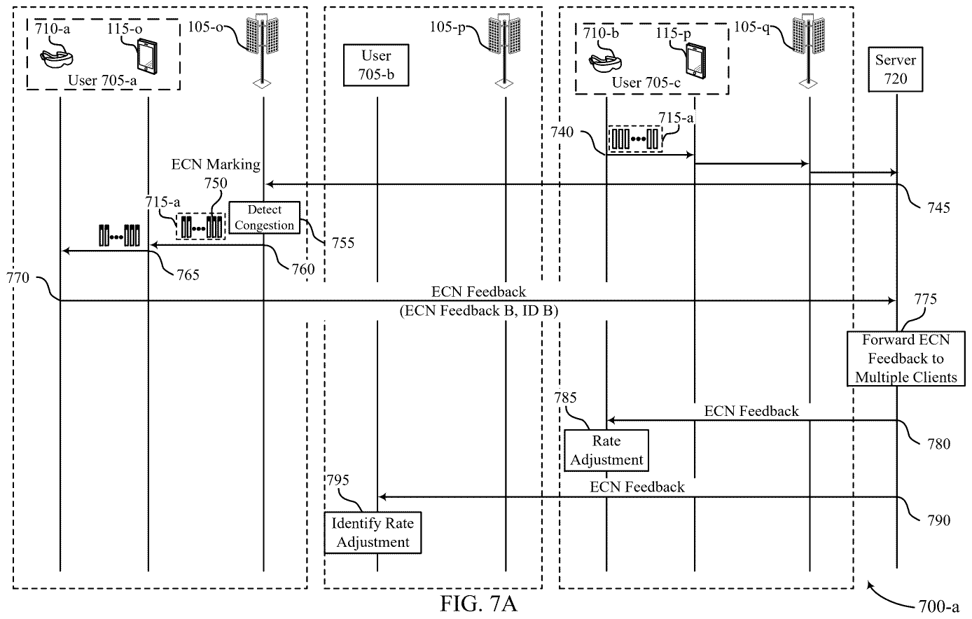

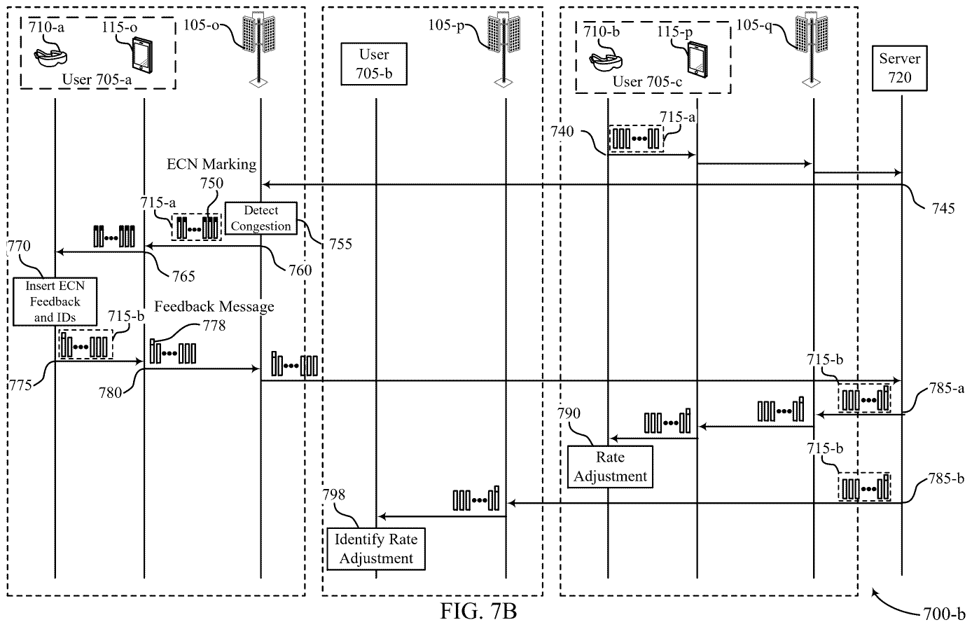

FIGS. 7A and 7B show examples of a process flow 700-a and a process flow 700-b, respectively, that support congestion handling for holographic communications in accordance with one or more aspects of the present disclosure. In some examples, the process flow 700-a and the process flow 700-b may implement or be implemented by aspects of the wireless communications system 100, the wireless communications system 200, the process flow 300-a, the process flow 300-b, the signaling diagram 301-a, the signaling diagram 301-b, the process flow 400, the process flow 500-a, the process flow 500-b, the process flow 600-a, the process flow 600-b, or any combination thereof. For example, the process flow 700-a and the process flow 700-b may include multiple users 705 (e.g., a first user 705-a, a second user 705-b, a third user 705-c), where each user may be associated with one or more wireless communication devices that support holographic communications. For example, the first user 705-a may be associated with a UE 115-o and/or one or more devices 710-a, which may be examples of the corresponding devices described herein (such as the UEs 115 and one or more devices 210 described with reference to FIG. 2). Similarly, the second user 705-b and the third user 705-c may be associated with one or more wireless communication devices, such as a UE 115-p and/or one or more devices 710-b for the third user 705-c. Although not shown for the second user 705-b, it is inherent that aspects of the holographic communications associated with the second user 705-b are performed by at least one wireless communication device (e.g., a UE 115, a peripheral device 710, or the like).

The process flow 700-a and the process flow 700-b further include one or more network entities 105, including a network entity 105-o, a network entity 105-p, and a network entity 105-q, that may each be an example of the corresponding network entities 105 described with reference to FIGS. 1 and 2. The process flow further includes an application server 720, which may be an example of the application server 220 and the application server 320 described with reference to FIGS. 2, 3A, 3B, 3C, 3D, 4, 5A, 5B, 6A, and 6B. The application server 720 may be associated with an SFU architecture that is utilized for holographic communications.

In the following description of the process flow 700-a and the process flow 700-b, the operations between the UEs 115, the network entities 105, and the application server 720 may be communicated in a different order than the example order shown, or the operations performed by one or more of the UEs 115, the network entities 105, and the application server 720 may be performed in different orders or at different times. Some operations may also be omitted from the process flow 700-a and/or the process flow 700-b, and other operations may be added to the process flow 700-a and/or the process flow 700-b. Further, as described herein, aspects of the functions performed by one or more of the UEs 115 may additionally, or alternatively, be performed by one or more other wireless communication devices (e.g., one or more peripheral devices).

The process flow 700-a may illustrate one or more techniques for proactive resource management for holographic communications. For example, when an application client (e.g., an application client of the one or more devices 710-a) detects congestion associated with a traffic flow transmitted by another application client (e.g., an application client of the one or more devices 710-b), application clients associated with other wireless communication devices, such as the devices associated with the second user 705-b, may benefit from being aware of the congestion. In particular, the application clients associated with the other wireless communication devices may expect that a data rate of the congested traffic flow (e.g., corresponding to packets 715-a transmitted by the one or more devices 710-b) may be reduced (e.g., in the near future).

In some examples, each application client associated with the other wireless communication devices (e.g., those not associated with a traffic flow experiencing congestion) may report an indication of a future rate reduction to a serving network entity, which may proactively adapt its resource management. As an example, after receiving an indication of ECN feedback associated with another traffic flow, one or more devices associated with the second user 705-b may transmit an indication of a future rate reduction to the network entity 105-p, and the network entity 105-p may manage various resources based on the possible rate reduction to be performed, for example, by the one or more devices 710-b. In such cases, the application clients for the second user 705-b may be notified of the downlink congestion of the traffic flow associated with the packets 715-a via the ECN feedback output by the application client for the one or more devices 710-a.

In the process flow 700-a, the features at 740, 745, 755, 760, and 765 may be similar to the features described herein, for example, with reference to the features at 640, 645, 655, 660, and 665 of FIG. 6A, and such features are not repeated here for the sake of brevity. Generally, the one or more devices 710-a of the first user 705-a may receive a set of packets 715-a that include one or more ECN markings 750 based on congestion detected by the network entity 105-o.

The application client of the one or more devices 710-a may identify the ECN marking 750 and, at 770, the one or more devices 710-a may transmit (e.g., the application client of the one or more devices 710-a may output) a feedback message to the application server 720. The feedback message may include ECN feedback (e.g., congestion information corresponding to the traffic flow of the set of packets 715-b (such as packet loss or other information)), and the feedback message may further include an ID (or one or more IDs) of the one or more devices 710-b (e.g., a wireless communication device that is a source of the set of packets 715-b). Additionally, or alternatively, the ID may be an ID of an application client associated with the one or more devices 710-b. As described herein, the feedback message transmitted at 770 may be sent via out-of-band signaling to the application server 720.

The application server 720 may receive the feedback message including the ECN feedback and the ID of the one or more devices 710-b and, at 775, the application server 720 may forward the ECN feedback to the one or more devices 710-b based on the ID included in the feedback message. For instance, at 780, the application server 720 may output the ECN feedback to the one or more devices 710-b (e.g., to the application client of the one or more devices 710-b), which may be signaled via the network entity 105-q and/or the UE 115-p. After receiving the ECN feedback at 780, the one or more devices 710-b may, at 785, modify a data rate associated with the traffic flow and in accordance with the congestion information provided by the ECN feedback. Accordingly, the modified data rate may be used to mitigate and/or eliminate the congestion detected for the traffic flow associated with the set of packets 715-b.

Additionally, in cases where the ECN feedback is transmitted as out-of-band signaling, the application server 720 may forward the ECN feedback to one or more application clients other than the one transmitting the congested flow (e.g., the application client associated with the one or more devices 710-b).

As an example, at 790, the application server 720 may forward the ECN feedback to the one or more devices associated with the second user 705-b. Here, at 790, the application server 720 may output the ECN feedback to the one or more devices (e.g., to the application client of the devices associated with the second user 705-b), which may be signaled via the network entity 105-p and/or a UE 115. After receiving the ECN feedback at 790, the one or more devices 710-b may, at 795, identify the (e.g., possible, likely) rate adjustment performed by the one or more devices 710-b at 785.

In some aspects, after reception of the ECN feedback about a traffic flow that is transmitted by another application client, an application client may predict (e.g., estimate) information about the future (e.g., modified) data rate of that other traffic flow. In some cases, the application client of a device may indicate, to one or more modem components of the device, the estimated data rate (e.g., via an X-Layer application programming interface (API)), and the one or more modem components of the device may transmit a message indicating the estimated data rate to a network entity 105. In some aspects, the report to the network entity 105 may be transmitted via an RRC message, a MAC-CE, via uplink control information (UCI) (e.g., layer 1 (L1) UCI), or any combination thereof. In some cases, report may include a quality of service (QoS) flow ID, or a logical channel ID of the traffic flow, the estimated data rate, or any combination thereof.

Additionally, or alternatively, and as shown in the process flow 700-b of FIG. 7B, the ECN feedback may be signaled to the application server 720 via the user plane, and the application server 720 may also forward the ECN feedback to one or more application clients of other wireless communication devices not associated with a traffic flow experiencing congestion. It is noted that the features of 740 through 765 of FIG. 7B may be the same as those described with reference to 740 through 765 of FIG. 7A and are not repeated again for the sake of brevity.

In FIG. 7B, the application client of the one or more devices 710-a may identify the ECN marking 750 and, at 770 of FIG. 7B, the one or more devices 710-a (e.g., the application client of the one or more devices 710-a) may insert ECN feedback and an ID (or one or more IDs) of the one or more devices 710-b and/or application client of the one or more devices 710-b (e.g., associated with a wireless communication device that is a source of the set of packets 715-a). Here, the ECN feedback may be based on the ECN marking 750 included with the set of packets 715-a, and may include, for example, congestion information (such as packet loss or other information corresponding to the congested traffic flow).

At 775 of FIG. 7B, the one or more devices 710-a may transmit (e.g., the application client of the one or more devices 710-a may output) a set of packets 715-b as part of the holographic communications (e.g., via the user plane, via in-band signaling). The set of packets 715-b include a feedback message 778 that provides an indication of the ECN feedback and the ID of the transmitting device, which may be included within one or more headers of the set of packets 715-b. That is, after detecting an ECN marking 750 in set of packets 715-a associated with a downlink flow from a transmitting application client (e.g., an application client of the one or more devices 710-b), the receiving application client (e.g., the application client of the one or more devices 710-a) may transmit the ECN Feedback to the transmitting application client via the data (e.g., video data) that the receiving application client is transmitting. As such, the set of packets 715-b may be received by the UE 115-o at 775 and, at 780 of FIG. 7B, the UE 115-o may transmit the set of packets 715-b to the application server 720 (e.g., via the network entity 105-o), where the set of packets may include the feedback message 778 when received by the application server 720.

Because the set of packets 715-b may be received via the user plane as part of the holographic communications, the application server 720 (e.g., associated with an SFU) may immediately forward the set of packets 715-b to other wireless communication devices included in the holographic communications session. For example, at 785-a of FIG. 7B, the application server 720 may output the set of packets 715-b to the third user 705-c (e.g., to the one or more devices 710-b of the third user 705-c, which may be sent via the network entity 105-q and/or the UE 115-p) and the application server 720 may output the set of packets 715-b at 785-b, to the device(s) of the second user 705-b. At 785-a of FIG. 7B, the packets forwarded to the third user 705-c may include the feedback message 778 that indicates the ECN feedback for the set of packets 715-a affected by the congestion. In response, at 790 of FIG. 7B, the one or more devices 710-b, after receiving the ECN feedback included in the set of packets 715-b, may modify a data rate associated with the traffic flow and in accordance with the congestion information provided by the ECN feedback. Accordingly, the modified data rate may be used to mitigate and/or eliminate the congestion detected for the traffic flow associated with the set of packets 715-a.

Further, at 785-b of FIG. 7B, the one or more devices associated with the second user 705-b may receive the ECN feedback included in the set of packets 715-b. At 798 of FIG. 7B, the device(s) of the second user 705-b (e.g., one or more application clients associated with the device(s) of the second user 705-b) may identify an estimated rate associated with an adjustment performed by the one or more devices 710-b at 785 of FIG. 7B.

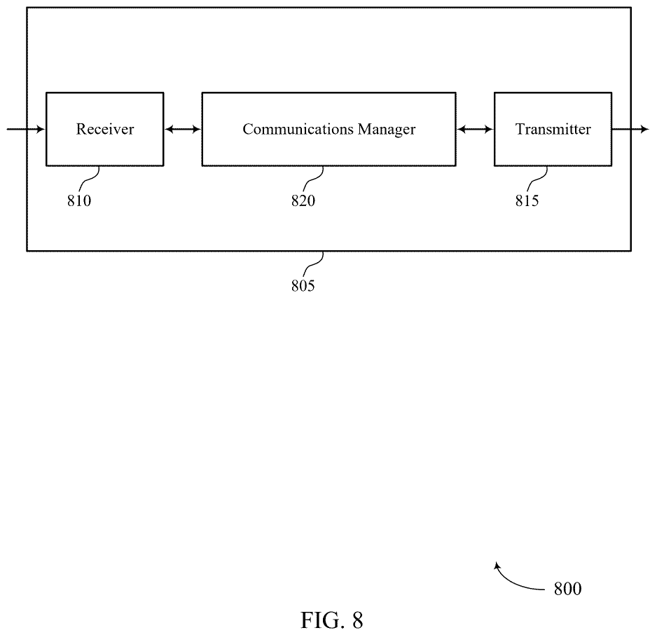

FIG. 8 shows a block diagram 800 of a device 805 that supports congestion handling for holographic communications in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to congestion handling for holographic communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to congestion handling for holographic communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of congestion handling for holographic communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a first set of packets of a traffic flow associated with holographic communications, where at least one packet of the first set of packets includes an explicit congestion notification marking. The communications manager 820 is capable of, configured to, or operable to support a means for transmitting, based on the explicit congestion notification marking, a feedback message including congestion information corresponding to the traffic flow, the feedback message further including an identifier of a second wireless communication device that is a source of the first set of packets.

Additionally, or alternatively, the communications manager 820 may support wireless communications in accordance with examples as disclosed herein. For example, the communications manager 820 is capable of, configured to, or operable to support a means for transmitting a first set of packets of a traffic flow associated with holographic communications. The communications manager 820 is capable of, configured to, or operable to support a means for receiving a feedback message including congestion information that is based on an explicit congestion notification marking of the first set of packets, the feedback message further including an identifier of the first wireless communication device, where the feedback message is received based on the identifier. The communications manager 820 is capable of, configured to, or operable to support a means for modifying a data rate associated with the traffic flow in accordance with the congestion information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and more efficient utilization of communication resources. For example, the techniques implemented by the device 805 may enable the mitigation of congestion for holographic communications, which may decrease latencies and improve resource usage (e.g., by avoiding or minimizing retransmissions and/or error correction procedures).

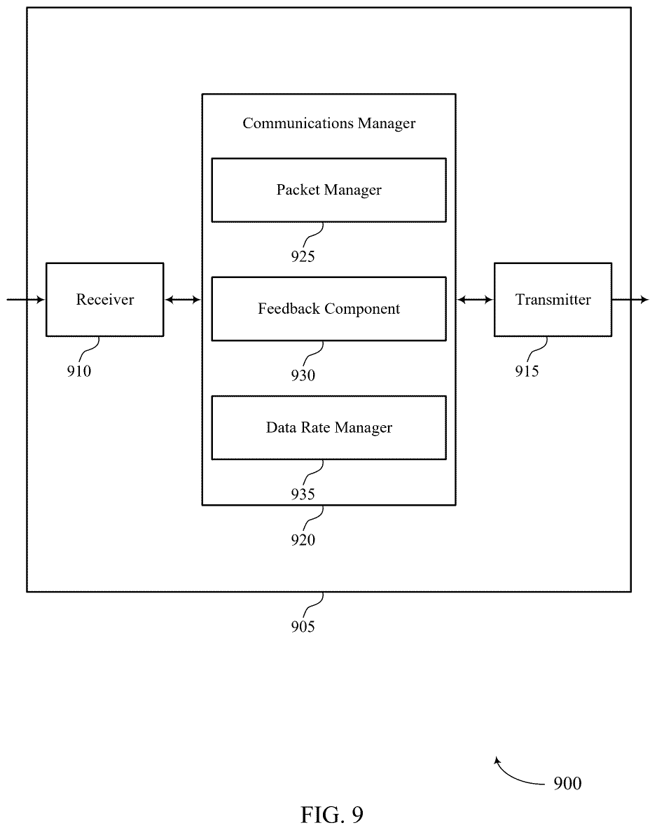

FIG. 9 shows a block diagram 900 of a device 905 that supports congestion handling for holographic communications in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to congestion handling for holographic communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to congestion handling for holographic communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of congestion handling for holographic communications as described herein. For example, the communications manager 920 may include a packet manager 925, a feedback component 930, a data rate manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The packet manager 925 is capable of, configured to, or operable to support a means for receiving a first set of packets of a traffic flow associated with holographic communications, where at least one packet of the first set of packets includes an explicit congestion notification marking. The feedback component 930 is capable of, configured to, or operable to support a means for transmitting, based on the explicit congestion notification marking, a feedback message including congestion information corresponding to the traffic flow, the feedback message further including an identifier of a second wireless communication device that is a source of the first set of packets.

Additionally, or alternatively, the communications manager 920 may support wireless communications in accordance with examples as disclosed herein. The packet manager 925 is capable of, configured to, or operable to support a means for transmitting a first set of packets of a traffic flow associated with holographic communications. The feedback component 930 is capable of, configured to, or operable to support a means for receiving a feedback message including congestion information that is based on an explicit congestion notification marking of the first set of packets, the feedback message further including an identifier of the first wireless communication device, where the feedback message is received based on the identifier. The data rate manager 935 is capable of, configured to, or operable to support a means for modifying a data rate associated with the traffic flow in accordance with the congestion information.

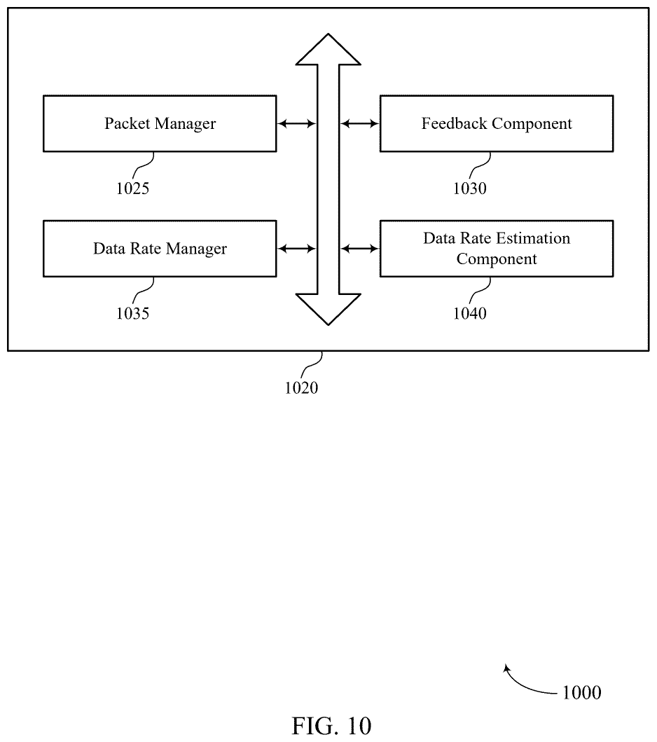

FIG. 10 shows a block diagram 1000 of a communications manager 1020 that supports congestion handling for holographic communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of congestion handling for holographic communications as described herein. For example, the communications manager 1020 may include a packet manager 1025, a feedback component 1030, a data rate manager 1035, a data rate estimation component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The packet manager 1025 is capable of, configured to, or operable to support a means for receiving a first set of packets of a traffic flow associated with holographic communications, where at least one packet of the first set of packets includes an explicit congestion notification marking. The feedback component 1030 is capable of, configured to, or operable to support a means for transmitting, based on the explicit congestion notification marking, a feedback message including congestion information corresponding to the traffic flow, the feedback message further including an identifier of a second wireless communication device that is a source of the first set of packets.

In some examples, to support transmitting the feedback message, the feedback component 1030 is capable of, configured to, or operable to support a means for transmitting the feedback message via a first channel that is different from a second channel associated with the holographic communications.

In some examples, to support transmitting the feedback message, the feedback component 1030 is capable of, configured to, or operable to support a means for transmitting a second set of packets associated with the holographic communications, the second set of packets including the feedback message including the congestion information and the identifier of the second wireless communication device.

In some examples, the congestion information and the identifier of the second wireless communication device are included in one or more headers of the second set of packets. In some examples, one or more packets of the second set of packets include the feedback message including the congestion information and the identifier of the second wireless communication device. In some examples, the feedback message further includes respective congestion information corresponding to one or more additional traffic flows and one or more respective identifiers of additional wireless communications devices that are sources of the one or more additional traffic flows. In some examples, the feedback message includes the respective congestion information and the one or more respective identifiers based on congestion associated with the traffic flow, congestion associated with the one or more additional traffic flows, or any combination thereof.

In some examples, to support transmitting the feedback message, the feedback component 1030 is capable of, configured to, or operable to support a means for transmitting a second set of packets associated with the holographic communications, the second set of packets including the feedback message that that further includes the respective congestion information and the one or more respective identifiers.

In some examples, to support transmitting the feedback message, the feedback component 1030 is capable of, configured to, or operable to support a means for transmitting the feedback message via a first channel that is different from a second channel associated with the holographic communications.

Additionally, or alternatively, the communications manager 1020 may support wireless communications in accordance with examples as disclosed herein. In some examples, the packet manager 1025 is capable of, configured to, or operable to support a means for transmitting a first set of packets of a traffic flow associated with holographic communications. In some examples, the feedback component 1030 is capable of, configured to, or operable to support a means for receiving a feedback message including congestion information that is based on an explicit congestion notification marking of the first set of packets, the feedback message further including an identifier of the first wireless communication device, where the feedback message is received based on the identifier. The data rate manager 1035 is capable of, configured to, or operable to support a means for modifying a data rate associated with the traffic flow in accordance with the congestion information.

In some examples, to support receiving the feedback message, the feedback component 1030 is capable of, configured to, or operable to support a means for receiving the feedback message via a first channel that is different from a second channel associated with the holographic communications.

In some examples, to support receiving the feedback message, the feedback component 1030 is capable of, configured to, or operable to support a means for receiving a second set of packets associated with the holographic communications, the second set of packets including the feedback message including the congestion information and the identifier of the first wireless communication device.

In some examples, the congestion information and the identifier of the first wireless communication device are included in one or more headers of the second set of packets. In some examples, one or more packets of the second set of packets include the feedback message including the congestion information and the identifier of the first wireless communication device. In some examples, the feedback message further includes respective congestion information corresponding to one or more additional traffic flows and one or more respective identifiers of additional wireless communications devices that are sources of packets of the one or more additional traffic flows.

In some examples, the data rate manager 1035 is capable of, configured to, or operable to support a means for modifying the data rate based on the respective congestion information and the one or more respective identifiers. In some examples, the feedback message includes the respective congestion information and the one or more respective identifiers based on congestion associated with the traffic flow, congestion associated with the one or more additional traffic flows, or any combination thereof.

In some examples, to support receiving the feedback message, the feedback component 1030 is capable of, configured to, or operable to support a means for receiving a second set of packets associated with the holographic communications, the second set of packets including the feedback message that that further includes the respective congestion information and the one or more respective identifiers.

In some examples, to support receiving the feedback message, the feedback component 1030 is capable of, configured to, or operable to support a means for receiving the feedback message via a first channel that is different from a second channel associated with the holographic communications.

In some examples, the feedback component 1030 is capable of, configured to, or operable to support a means for receiving a second feedback message including respective congestion information corresponding to one or more additional traffic flows and one or more respective identifiers of additional wireless communications devices that are sources of packets of the one or more additional traffic flows.

In some examples, the feedback component 1030 is capable of, configured to, or operable to support a means for ignoring the second feedback message based on the identifier of the first wireless communication device being different from the one or more respective identifiers. In some examples, the data rate estimation component 1040 is capable of, configured to, or operable to support a means for calculating an estimated data rate based on the respective congestion information corresponding to the one or more additional traffic flows.

In some examples, the data rate estimation component 1040 is capable of, configured to, or operable to support a means for transmitting one or more messages indicating the estimated data rate, a quality of service (QoS) flow identifier, a logical channel identifier, or any combination thereof, where the one or more messages include a radio resource control message, a medium access control (MAC) control element, uplink control information, or any combination thereof.

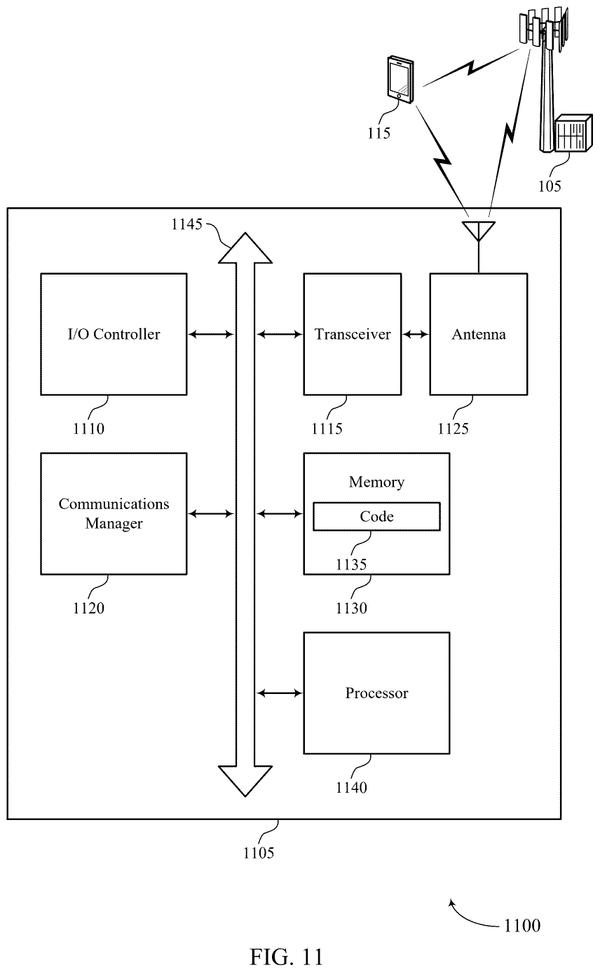

FIG. 11 shows a diagram of a system 1100 including a device 1105 that supports congestion handling for holographic communications in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting congestion handling for holographic communications). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a first set of packets of a traffic flow associated with holographic communications, where at least one packet of the first set of packets includes an explicit congestion notification marking. The communications manager 1120 is capable of, configured to, or operable to support a means for transmitting, based on the explicit congestion notification marking, a feedback message including congestion information corresponding to the traffic flow, the feedback message further including an identifier of a second wireless communication device that is a source of the first set of packets.

Additionally, or alternatively, the communications manager 1120 may support wireless communications in accordance with examples as disclosed herein. For example, the communications manager 1120 is capable of, configured to, or operable to support a means for transmitting a first set of packets of a traffic flow associated with holographic communications. The communications manager 1120 is capable of, configured to, or operable to support a means for receiving a feedback message including congestion information that is based on an explicit congestion notification marking of the first set of packets, the feedback message further including an identifier of the first wireless communication device, where the feedback message is received based on the identifier. The communications manager 1120 is capable of, configured to, or operable to support a means for modifying a data rate associated with the traffic flow in accordance with the congestion information.

By including or configuring the communications manager 1120 in accordance with examples as described herein, the device 1105 may support techniques for improved communication reliability, reduced latency, improved user experience related to reduced processing, reduced power consumption, more efficient utilization of communication resources, and improved utilization of processing capability, among other examples. For example, the techniques implemented by the device 1105 may enable the mitigation of congestion for holographic communications, which may decrease latencies and improve resource usage (e.g., by avoiding or minimizing retransmissions and/or error correction procedures). Similarly, the described techniques may prevent congestion from going unnoticed by a transmitting device, which may perform one or more operations to mitigate the congestion (such as reducing a data rate).

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of congestion handling for holographic communications as described herein, or the at least one processor 1140 and the at least one memory 1130 may be otherwise configured to, individually or collectively, perform or support such operations.

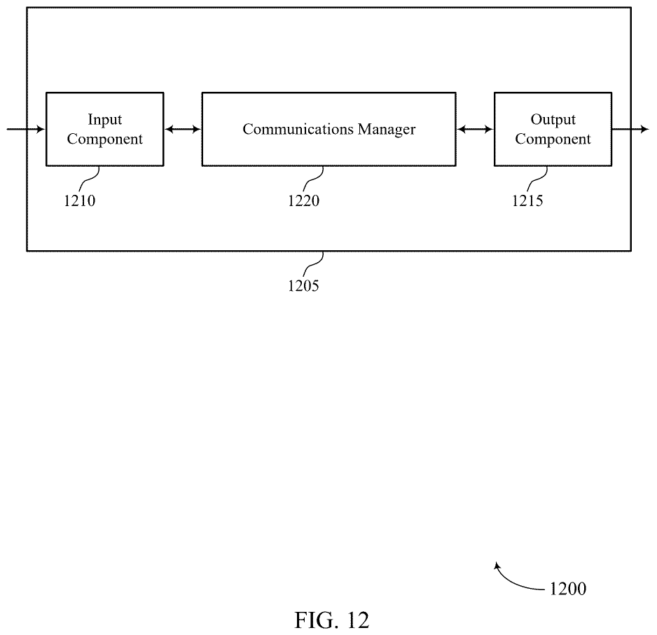

FIG. 12 shows a block diagram 1200 of a device 1205 that supports congestion handling for holographic communications in accordance with one or more aspects of the present disclosure. The device 1205 may be an example of aspects of an application server as described herein. The device 1205 may include an input component 1210, an output component 1215, and a communications manager 1220. The device 1205, or one or more components of the device 1205 (e.g., the input component 1210, the output component 1215, the communications manager 1220), may include at least one processor, which may be coupled with at least one memory, to, individually or collectively, support or enable the described techniques. Each of these components may be in communication with one another (e.g., via one or more buses).

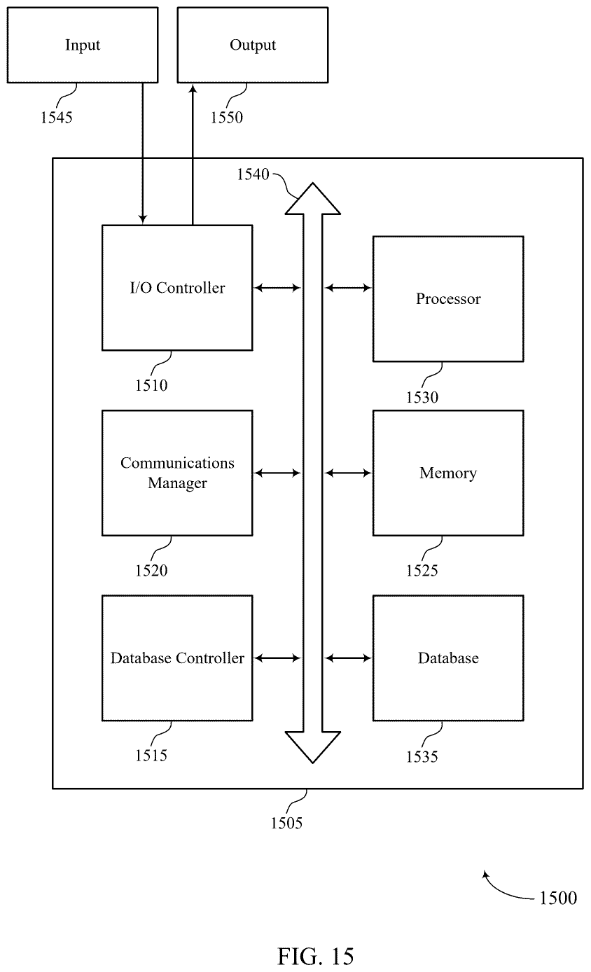

The input component 1210 may manage input signals for the device 1205. For example, the input component 1210 may identify input signals based on an interaction with a modem, a keyboard, a mouse, a touchscreen, or a similar device. These input signals may be associated with user input or processing at other components or devices. In some cases, the input component 1210 may utilize an operating system such as iOS®, ANDROID®, MS-DOS®, MS-WINDOWS®, OS/2®, UNIX®, LINUX®, or another known operating system to handle input signals. The input component 1210 may send aspects of these input signals to other components of the device 1205 for processing. For example, the input component 1210 may transmit input signals to the communications manager 1220 to support congestion handling for holographic communications. In some cases, the input component 1210 may be a component of an I/O controller 1510 as described with reference to FIG. 15.

The output component 1215 may manage output signals for the device 1205. For example, the output component 1215 may receive signals from other components of the device 1205, such as the communications manager 1220, and may transmit these signals to other components or devices. In some specific examples, the output component 1215 may transmit output signals for display in a user interface, for storage in a database or data store, for further processing at a server or server cluster, or for any other processes at any number of devices or systems. In some cases, the output component 1215 may be a component of an I/O controller 1510 as described with reference to FIG. 15.

The communications manager 1220, the input component 1210, the output component 1215, or various combinations or components thereof may be examples of means for performing various aspects of congestion handling for holographic communications as described herein. For example, the communications manager 1220, the input component 1210, the output component 1215, or various combinations or components thereof may be capable of performing one or more of the functions described herein.

In some examples, the communications manager 1220, the input component 1210, the output component 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the input component 1210, the output component 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the input component 1210, the output component 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the input component 1210, the output component 1215, or both. For example, the communications manager 1220 may receive information from the input component 1210, send information to the output component 1215, or be integrated in combination with the input component 1210, the output component 1215, or both to obtain information, output information, or perform various other operations as described herein.

The communications manager 1220 may support wireless communication in accordance with examples as disclosed herein. For example, the communications manager 1220 is capable of, configured to, or operable to support a means for obtaining a first set of packets of a traffic flow associated with holographic communications between a set of multiple wireless communication devices, where the first set of packets is obtained from a first wireless communication device of the set of multiple wireless communication devices. The communications manager 1220 is capable of, configured to, or operable to support a means for outputting a second set of packets of the traffic flow, the second set of packets corresponding to the first set of packets and output to each wireless communication device of the set of multiple wireless communication devices. The communications manager 1220 is capable of, configured to, or operable to support a means for obtaining a first feedback message including congestion information that is based on an explicit congestion notification marking of the first set of packets, the first feedback message further including one or more respective identifiers of one or more wireless communication devices of the set of multiple wireless communication devices. The communications manager 1220 is capable of, configured to, or operable to support a means for outputting a second feedback message based on the congestion information and the one or more respective identifiers of the one or more wireless communication devices included in the first feedback message.

By including or configuring the communications manager 1220 in accordance with examples as described herein, the device 1205 (e.g., at least one processor controlling or otherwise coupled with the input component 1210, the output component 1215, the communications manager 1220, or a combination thereof) may support techniques for reduced processing and more efficient utilization of communication resources. For example, the techniques implemented by the device 1205 may enable the mitigation of congestion for holographic communications, which may decrease latencies and improve resource usage (e.g., by avoiding or minimizing retransmissions and/or error correction procedures).

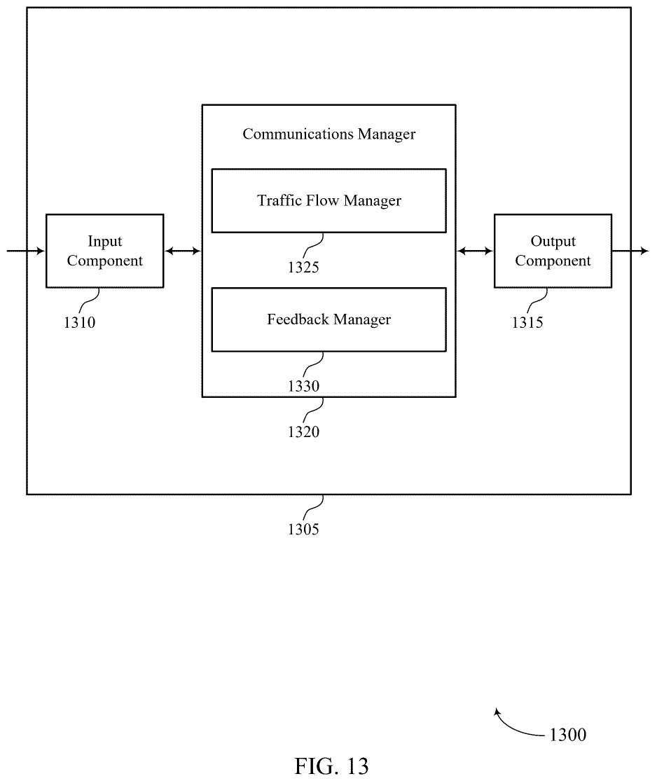

FIG. 13 shows a block diagram 1300 of a device 1305 that supports congestion handling for holographic communications in accordance with one or more aspects of the present disclosure. The device 1305 may be an example of aspects of a device 1205 or an application server as described herein. The device 1305 may include an input component 1310, an output component 1315, and a communications manager 1320. The device 1305, or one or more components of the device 1305 (e.g., the input component 1310, the output component 1315, the communications manager 1320), may include at least one processor, which may be coupled with at least one memory, to support the described techniques. Each of these components may be in communication with one another (e.g., via one or more buses).

The input component 1310 may manage input signals for the device 1305. For example, the input component 1310 may identify input signals based on an interaction with a modem, a keyboard, a mouse, a touchscreen, or a similar device. These input signals may be associated with user input or processing at other components or devices. In some cases, the input component 1310 may utilize an operating system such as iOS®, ANDROID®, MS-DOS®, MS-WINDOWS®, OS/2®, UNIX®, LINUX®, or another known operating system to handle input signals. The input component 1310 may send aspects of these input signals to other components of the device 1305 for processing. For example, the input component 1310 may transmit input signals to the communications manager 1320 to support congestion handling for holographic communications. In some cases, the input component 1310 may be a component of an I/O controller 1510 as described with reference to FIG. 15.

The output component 1315 may manage output signals for the device 1305. For example, the output component 1315 may receive signals from other components of the device 1305, such as the communications manager 1320, and may transmit these signals to other components or devices. In some specific examples, the output component 1315 may transmit output signals for display in a user interface, for storage in a database or data store, for further processing at a server or server cluster, or for any other processes at any number of devices or systems. In some cases, the output component 1315 may be a component of an I/O controller 1510 as described with reference to FIG. 15.

The device 1305, or various components thereof, may be an example of means for performing various aspects of congestion handling for holographic communications as described herein. For example, the communications manager 1320 may include a traffic flow manager 1325 a feedback manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the input component 1310, the output component 1315, or both. For example, the communications manager 1320 may receive information from the input component 1310, send information to the output component 1315, or be integrated in combination with the input component 1310, the output component 1315, or both to obtain information, output information, or perform various other operations as described herein.

The communications manager 1320 may support wireless communication in accordance with examples as disclosed herein. The traffic flow manager 1325 is capable of, configured to, or operable to support a means for obtaining a first set of packets of a traffic flow associated with holographic communications between a set of multiple wireless communication devices, where the first set of packets is obtained from a first wireless communication device of the set of multiple wireless communication devices. The traffic flow manager 1325 is capable of, configured to, or operable to support a means for outputting a second set of packets of the traffic flow, the second set of packets corresponding to the first set of packets and output to each wireless communication device of the set of multiple wireless communication devices. The feedback manager 1330 is capable of, configured to, or operable to support a means for obtaining a first feedback message including congestion information that is based on an explicit congestion notification marking of the first set of packets, the first feedback message further including one or more respective identifiers of one or more wireless communication devices of the set of multiple wireless communication devices. The feedback manager 1330 is capable of, configured to, or operable to support a means for outputting a second feedback message based on the congestion information and the one or more respective identifiers of the one or more wireless communication devices included in the first feedback message.

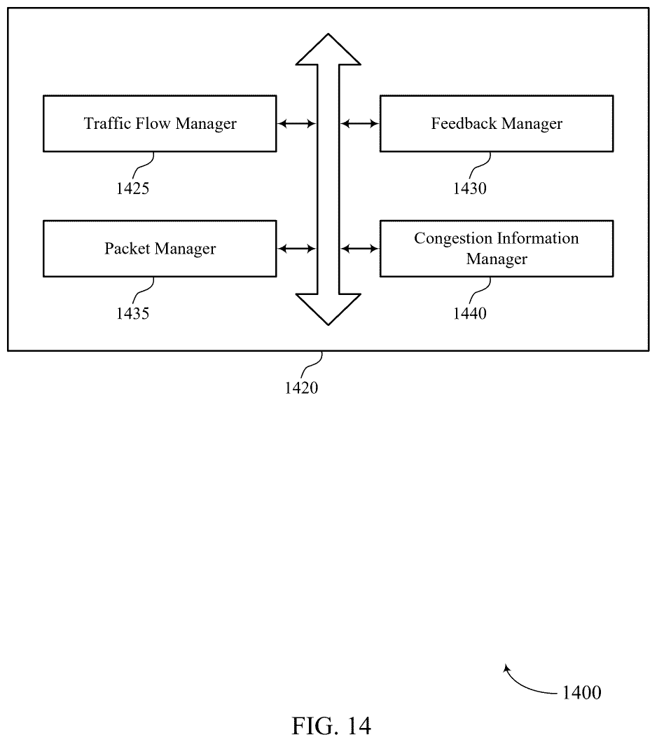

FIG. 14 shows a block diagram 1400 of a communications manager 1420 that supports congestion handling for holographic communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of congestion handling for holographic communications as described herein. For example, the communications manager 1420 may include a traffic flow manager 1425, a feedback manager 1430, a packet manager 1435, a congestion information manager 1440, or any combination thereof. Each of these components, or components or subcomponents thereof (e.g., one or more processors, one or more memories), may communicate, directly or indirectly, with one another (e.g., via one or more buses).

The communications manager 1420 may support wireless communication in accordance with examples as disclosed herein. The traffic flow manager 1425 is capable of, configured to, or operable to support a means for obtaining a first set of packets of a traffic flow associated with holographic communications between a set of multiple wireless communication devices, where the first set of packets is obtained from a first wireless communication device of the set of multiple wireless communication devices. In some examples, the traffic flow manager 1425 is capable of, configured to, or operable to support a means for outputting a second set of packets of the traffic flow, the second set of packets corresponding to the first set of packets and output to each wireless communication device of the set of multiple wireless communication devices. The feedback manager 1430 is capable of, configured to, or operable to support a means for obtaining a first feedback message including congestion information that is based on an explicit congestion notification marking of the first set of packets, the first feedback message further including one or more respective identifiers of one or more wireless communication devices of the set of multiple wireless communication devices. In some examples, the feedback manager 1430 is capable of, configured to, or operable to support a means for outputting a second feedback message based on the congestion information and the one or more respective identifiers of the one or more wireless communication devices included in the first feedback message.

In some examples, to support obtaining the first feedback message, the feedback manager 1430 is capable of, configured to, or operable to support a means for obtaining the first feedback message via a first channel that is different from a second channel associated with the holographic communications, the first feedback message including a first identifier of the first wireless communication device. In some examples, the feedback manager 1430 is capable of, configured to, or operable to support a means for outputting the second feedback message to the first wireless communication device via the first channel and in accordance with the first feedback message including the first identifier.

In some examples, to support obtaining the first feedback message, the packet manager 1435 is capable of, configured to, or operable to support a means for obtaining a third set of packets associated with the holographic communications, the third set of packets including the first feedback message, the first feedback message including a first identifier of the first wireless communication device. In some examples, the packet manager 1435 is capable of, configured to, or operable to support a means for outputting a fourth set of packets including the second feedback message, the fourth set of packets output to each wireless communication device of the set of multiple wireless communication devices.

In some examples, the congestion information and the one or more respective identifiers are included in one or more headers of the third set of packets. In some examples, one or more packets of the third set of packets include the first feedback message including the congestion information and the one or more respective identifiers.

In some examples, to support obtaining the first feedback message, the packet manager 1435 is capable of, configured to, or operable to support a means for obtaining a third set of packets associated with the holographic communications, the third set of packets including the first feedback message, the first feedback message including a first identifier of the first wireless communication device. In some examples, the packet manager 1435 is capable of, configured to, or operable to support a means for outputting a fourth set of packets including the second feedback message, the fourth set of packets output to the first wireless communication device based on the first identifier. In some examples, to support obtaining the first feedback message, the packet manager 1435 is capable of, configured to, or operable to support a means for outputting a fifth set of packets that exclude the second feedback message, the fifth set of packets output to other wireless communication devices of the set of multiple wireless communication devices.

In some examples, to support obtaining the first feedback message, the feedback manager 1430 is capable of, configured to, or operable to support a means for obtaining the first feedback message via a first channel that is different from a second channel associated with the holographic communications, where the first feedback message further includes respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows. In some examples, the feedback manager 1430 is capable of, configured to, or operable to support a means for outputting the second feedback message to the one or more other wireless communications devices corresponding to the one or more other respective identifiers.

In some examples, to support obtaining the first feedback message, the feedback manager 1430 is capable of, configured to, or operable to support a means for obtaining a third set of packets associated with the holographic communications, the third set of packets including the first feedback message, where the first feedback message further includes respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows. In some examples, the feedback manager 1430 is capable of, configured to, or operable to support a means for outputting a fourth set of packets including the second feedback message, the fourth set of packets output to each wireless communication device of the set of multiple wireless communication devices.

In some examples, the first feedback message further includes respective congestion information corresponding to one or more additional traffic flows and one or more other respective identifiers from among the one or more respective identifiers corresponding to one or more other wireless communications devices different from the first wireless communication device that are sources of packets of the one or more additional traffic flows, and the congestion information manager 1440 is capable of, configured to, or operable to support a means for modifying the congestion information, the one or more other respective identifiers, or both, included in the second feedback message based on the first feedback message including the respective congestion information and the one or more other respective identifiers of the one or more other wireless communications devices.

In some examples, to support obtaining the first feedback message, the feedback manager 1430 is capable of, configured to, or operable to support a means for obtaining the first feedback message via a first channel that is different from a second channel associated with the holographic communications, the first feedback message including a first identifier of the first wireless communication device. In some examples, the feedback manager 1430 is capable of, configured to, or operable to support a means for outputting the second feedback message via the first channel to one or more other wireless communication devices of the set of multiple wireless communication devices.

FIG. 15 shows a diagram of a system 1500 including a device 1505 that supports congestion handling for holographic communications in accordance with one or more aspects of the present disclosure. The device 1505 may be an example of or include components of a device 1205, a device 1305, or an application server as described herein. The device 1505 may include components for bi-directional voice and data communications including components for transmitting and receiving communications, such as a communications manager 1520, an I/O controller, such as an I/O controller 1510, a database controller 1515, at least one memory 1525, at least one processor 1530, and a database 1535. These components may be in electronic communication or otherwise coupled (e.g., operatively, communicatively, functionally, electronically, electrically) via one or more buses (e.g., a bus 1540).

The I/O controller 1510 may manage input signals 1545 and output signals 1550 for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of a processor. In some examples, a user may interact with the device 1505 via the I/O controller 1510 or via hardware components controlled by the I/O controller 1510.

The database controller 1515 may manage data storage and processing in a database 1535. The database 1535 may be external to the device 1505, temporarily or permanently connected to the device 1505, or a data storage component of the device 1505. In some cases, a user may interact with the database controller 1515. In some other cases, the database controller 1515 may operate automatically without user interaction. The database 1535 may be an example of a persistent data store, a single database, a distributed database, multiple distributed databases, a database management system, or an emergency backup database.

Memory 1525 may include random-access memory (RAM) and ROM. The memory 1525 may store computer-readable, computer-executable software including instructions that, when executed, cause the processor to perform various functions described herein. In some cases, the memory 1525 may contain, among other things, a BIOS which may control basic hardware or software operation such as the interaction with peripheral components or devices.

The processor 1530 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1530 may be configured to operate a memory array using a memory controller. In some other cases, a memory controller may be integrated into the processor 1530. The processor 1530 may be configured to execute computer-readable instructions stored in memory 1525 to perform various functions (e.g., functions or tasks supporting congestion handling for holographic communications).

The communications manager 1520 may support wireless communication in accordance with examples as disclosed herein. For example, the communications manager 1520 is capable of, configured to, or operable to support a means for obtaining a first set of packets of a traffic flow associated with holographic communications between a set of multiple wireless communication devices, where the first set of packets is obtained from a first wireless communication device of the set of multiple wireless communication devices. The communications manager 1520 is capable of, configured to, or operable to support a means for outputting a second set of packets of the traffic flow, the second set of packets corresponding to the first set of packets and output to each wireless communication device of the set of multiple wireless communication devices. The communications manager 1520 is capable of, configured to, or operable to support a means for obtaining a first feedback message including congestion information that is based on an explicit congestion notification marking of the first set of packets, the first feedback message further including one or more respective identifiers of one or more wireless communication devices of the set of multiple wireless communication devices. The communications manager 1520 is capable of, configured to, or operable to support a means for outputting a second feedback message based on the congestion information and the one or more respective identifiers of the one or more wireless communication devices included in the first feedback message.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, and improved utilization of processing capability, among other examples.

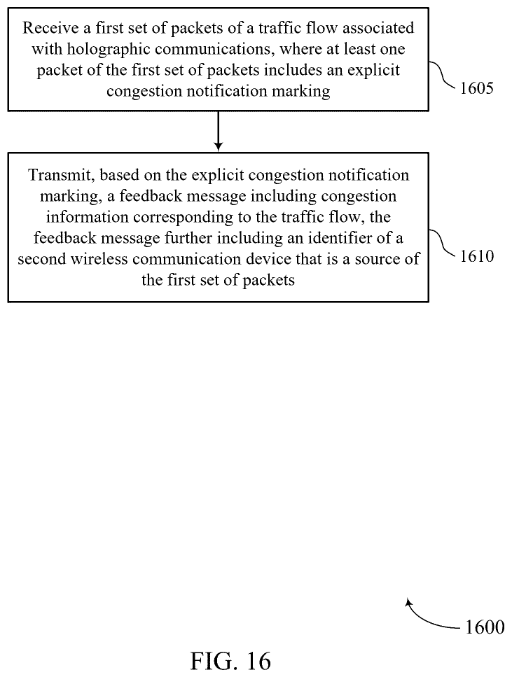

FIG. 16 shows a flowchart illustrating a method 1600 that supports congestion handling for holographic communications in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a first set of packets of a traffic flow associated with holographic communications, where at least one packet of the first set of packets includes an explicit congestion notification marking. The operations of 1605 may be performed in accordance with examples as disclosed herein, such as with reference to the reception of the set of packets 415-b by the UE 115-h and/or the one or more devices 410-a, as described with reference to FIG. 4. In some examples, aspects of the operations of 1605 may be performed by a packet manager 1025 as described with reference to FIG. 10.

At 1610, the method may include transmitting, based on the explicit congestion notification marking, a feedback message including congestion information corresponding to the traffic flow, the feedback message further including an identifier of a second wireless communication device that is a source of the first set of packets. The operations of 1610 may be performed in accordance with examples as disclosed herein, such as the transmission of the feedback message at 470 described with reference to FIG. 4 and the transmission of the feedback message at 575 of FIGS. 5A and 5B, among other examples. In some examples, aspects of the operations of 1610 may be performed by a feedback component 1030 as described with reference to FIG. 10.

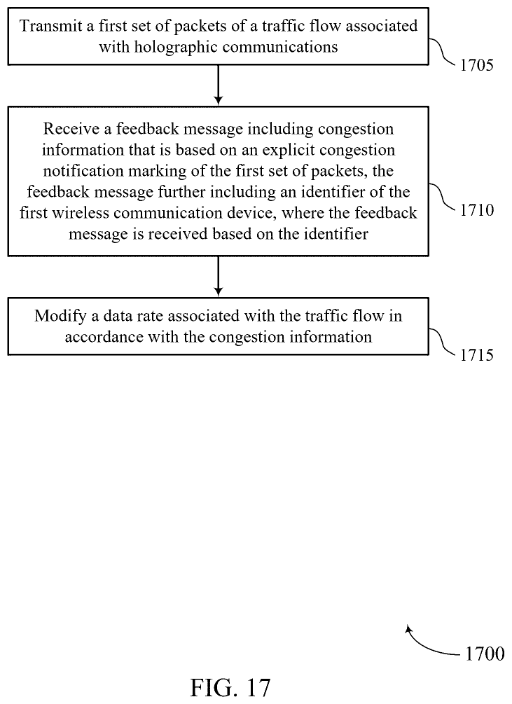

FIG. 17 shows a flowchart illustrating a method 1700 that supports congestion handling for holographic communications in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting a first set of packets of a traffic flow associated with holographic communications. The operations of 1705 may be performed in accordance with examples as disclosed herein, such as the transmission of the set of packets 415-b, as described with reference to FIG. 4. In some examples, aspects of the operations of 1705 may be performed by a packet manager 1025 as described with reference to FIG. 10.

At 1710, the method may include receiving a feedback message including congestion information that is based on an explicit congestion notification marking of the first set of packets, the feedback message further including an identifier of the first wireless communication device, where the feedback message is received based on the identifier. The operations of 1710 may be performed in accordance with examples as disclosed herein, such as the reception of the ECN feedback at 480, as described with reference to FIG. 4. In some examples, aspects of the operations of 1710 may be performed by a feedback component 1030 as described with reference to FIG. 10.

At 1715, the method may include modifying a data rate associated with the traffic flow in accordance with the congestion information. The operations of 1715 may be performed in accordance with examples as disclosed herein, such as the rate adjustment at 485, as described with reference to FIG. 4. In some examples, aspects of the operations of 1715 may be performed by a data rate manager 1035 as described with reference to FIG. 10.

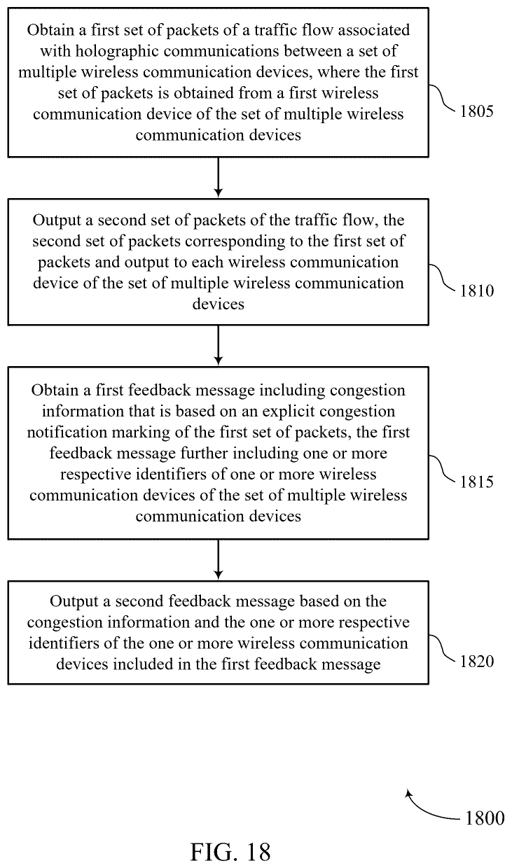

FIG. 18 shows a flowchart illustrating a method 1800 that supports congestion handling for holographic communications in accordance with one or more aspects of the present disclosure. The operations of the method 1800 may be implemented by a Generic Device or its components as described herein. For example, the operations of the method 1800 may be performed by a Generic Device as described with reference to FIGS. 1 through 7 and 12 through 15. In some examples, a Generic Device may execute a set of instructions to control the functional elements of the Generic Device to perform the described functions. Additionally, or alternatively, the Generic Device may perform aspects of the described functions using special-purpose hardware.

At 1805, the method may include obtaining a first set of packets of a traffic flow associated with holographic communications between a set of multiple wireless communication devices, where the first set of packets is obtained from a first wireless communication device of the set of multiple wireless communication devices. The operations of 1805 may be performed in accordance with examples as disclosed herein, such as the reception of the set of packets 415-b described with reference to FIG. 4. In some examples, aspects of the operations of 1805 may be performed by a traffic flow manager 1425 as described with reference to FIG. 14.

At 1810, the method may include outputting a second set of packets of the traffic flow, the second set of packets corresponding to the first set of packets and output to each wireless communication device of the set of multiple wireless communication devices. The operations of 1810 may be performed in accordance with examples as disclosed herein, such as the output of the set of packets 415-b at 445 of FIG. 4, among other examples. In some examples, aspects of the operations of 1810 may be performed by a traffic flow manager 1425 as described with reference to FIG. 14.

At 1815, the method may include obtaining a first feedback message including congestion information that is based on an explicit congestion notification marking of the first set of packets, the first feedback message further including one or more respective identifiers of one or more wireless communication devices of the set of multiple wireless communication devices. The operations of 1815 may be performed in accordance with examples as disclosed herein, such as the reception of the feedback message at 470 described with reference to FIG. 4 and the reception of the feedback message at 575 of FIGS. 5A and 5B, among other examples. In some examples, aspects of the operations of 1815 may be performed by a feedback manager 1430 as described with reference to FIG. 14.

At 1820, the method may include outputting a second feedback message based on the congestion information and the one or more respective identifiers of the one or more wireless communication devices included in the first feedback message. The operations of 1820 may be performed in accordance with examples as disclosed herein, such as the output of the ECN feedback at 480 described with reference to FIG. 4, among other examples. In some examples, aspects of the operations of 1820 may be performed by a feedback manager 1430 as described with reference to FIG. 14.

The following provides an overview of aspects of the present disclosure:

Aspect 1: A method for wireless communications by a first wireless communication device, comprising: receiving a first set of packets of a traffic flow associated with holographic communications, wherein at least one packet of the first set of packets includes an explicit congestion notification marking; and transmitting, based at least in part on the explicit congestion notification marking, a feedback message comprising congestion information corresponding to the traffic flow, the feedback message further comprising an identifier of a second wireless communication device that is a source of the first set of packets.

Aspect 2: The method of aspect 1, wherein transmitting the feedback message comprises: transmitting the feedback message via a first channel that is different from a second channel associated with the holographic communications.

Aspect 3: The method of aspect 1, wherein transmitting the feedback message comprises: transmitting a second set of packets associated with the holographic communications, the second set of packets including the feedback message comprising the congestion information and the identifier of the second wireless communication device.

Aspect 4: The method of aspect 3, wherein the congestion information and the identifier of the second wireless communication device are included in one or more headers of the second set of packets.

Aspect 5: The method of any of aspects 3 through 4, wherein one or more packets of the second set of packets include the feedback message comprising the congestion information and the identifier of the second wireless communication device.

Aspect 6: The method of aspect 1, wherein the feedback message further comprises respective congestion information corresponding to one or more additional traffic flows and one or more respective identifiers of additional wireless communications devices that are sources of the one or more additional traffic flows.

Aspect 7: The method of aspect 6, wherein the feedback message comprises the respective congestion information and the one or more respective identifiers based at least in part on congestion associated with the traffic flow, congestion associated with the one or more additional traffic flows, or any combination thereof.

Aspect 8: The method of any of aspects 6 through 7, wherein transmitting the feedback message comprises: transmitting a second set of packets associated with the holographic communications, the second set of packets including the feedback message that that further comprises the respective congestion information and the one or more respective identifiers.

Aspect 9: The method of any of aspects 6 through 7, wherein transmitting the feedback message comprises: transmitting the feedback message via a first channel that is different from a second channel associated with the holographic communications.

Aspect 10: A method for wireless communications by a first wireless communication device, comprising: transmitting a first set of packets of a traffic flow associated with holographic communications; receiving a feedback message comprising congestion information that is based at least in part on an explicit congestion notification marking of the first set of packets, the feedback message further comprising an identifier of the first wireless communication device, wherein the feedback message is received based at least in part on the identifier; and modifying a data rate associated with the traffic flow in accordance with the congestion information.

Aspect 11: The method of aspect 10, wherein receiving the feedback message comprises: receiving the feedback message via a first channel that is different from a second channel associated with the holographic communications.

Aspect 12: The method of aspect 10, wherein receiving the feedback message comprises: receiving a second set of packets associated with the holographic communications, the second set of packets including the feedback message comprising the congestion information and the identifier of the first wireless communication device.

Aspect 13: The method of aspect 12, wherein the congestion information and the identifier of the first wireless communication device are included in one or more headers of the second set of packets.

Aspect 14: The method of any of aspects 12 through 13, wherein one or more packets of the second set of packets include the feedback message comprising the congestion information and the identifier of the first wireless communication device.

Aspect 15: The method of aspect 10, wherein the feedback message further comprises respective congestion information corresponding to one or more additional traffic flows and one or more respective identifiers of additional wireless communications devices that are sources of packets of the one or more additional traffic flows.

Aspect 16: The method of aspect 15, further comprising: modifying the data rate based at least in part on the respective congestion information and the one or more respective identifiers.

Aspect 17: The method of any of aspects 15 through 16, wherein the feedback message comprises the respective congestion information and the one or more respective identifiers based at least in part on congestion associated with the traffic flow, congestion associated with the one or more additional traffic flows, or any combination thereof.

Aspect 18: The method of any of aspects 15 through 16, wherein receiving the feedback message comprises: receiving a second set of packets associated with the holographic communications, the second set of packets including the feedback message that that further comprises the respective congestion information and the one or more respective identifiers.

Aspect 19: The method of any of aspects 15 through 16, wherein receiving the feedback message comprises: receiving the feedback message via a first channel that is different from a second channel associated with the holographic communications.

Aspect 20: The method of aspect 10, further comprising: receiving a second feedback message comprising respective congestion information corresponding to one or more additional traffic flows and one or more respective identifiers of additional wireless communications devices that are sources of packets of the one or more additional traffic flows.

Aspect 21: The method of aspect 20, further comprising: ignoring the second feedback message based at least in part on the identifier of the first wireless communication device being different from the one or more respective identifiers.

Aspect 22: The method of any of aspects 20 through 21, further comprising: calculating an estimated data rate based at least in part on the respective congestion information corresponding to the one or more additional traffic flows.

Aspect 23: The method of aspect 22, further comprising: transmitting one or more messages indicating the estimated data rate, a quality of service (QoS) flow identifier, a logical channel identifier, or any combination thereof, wherein the one or more messages comprise a radio resource control message, a medium access control (MAC) control element, uplink control information, or any combination thereof.

Aspect 24: A method for wireless communication by an application server, comprising: obtaining a first set of packets of a traffic flow associated with holographic communications between a plurality of wireless communication devices, wherein the first set of packets is obtained from a first wireless communication device of the plurality of wireless communication devices; outputting a second set of packets of the traffic flow, the second set of packets corresponding to the first set of packets and output to each wireless communication device of the plurality of wireless communication devices; obtaining a first feedback message comprising congestion information that is based at least in part on an explicit congestion notification marking of the first set of packets, the first feedback message further comprising one or more respective identifiers of one or more wireless communication devices of the plurality of wireless communication devices; and outputting a second feedback message based at least in part on the congestion information and the one or more respective identifiers of the one or more wireless communication devices included in the first feedback message.

Aspect 25: The method of aspect 24, wherein obtaining the first feedback message comprises: obtaining the first feedback message via a first channel that is different from a second channel associated with the holographic communications, the first feedback message comprising a first identifier of the first wireless communication device, wherein outputting the second feedback message comprises: outputting the second feedback message to the first wireless communication device via the first channel and in accordance with the first feedback message comprising the first identifier.

Aspect 26: The method of aspect 24, wherein obtaining the first feedback message comprises: obtaining a third set of packets associated with the holographic communications, the third set of packets including the first feedback message, the first feedback message comprising a first identifier of the first wireless communication device, wherein outputting the second feedback message comprises: outputting a fourth set of packets including the second feedback message, the fourth set of packets output to each wireless communication device of the plurality of wireless communication devices.

Aspect 27: The method of aspect 26, wherein the congestion information and the one or more respective identifiers are included in one or more headers of the third set of packets.

Aspect 28: The method of any of aspects 26 through 27, wherein one or more packets of the third set of packets include the first feedback message comprising the congestion information and the one or more respective identifiers.

Aspect 29: The method of aspect 24, wherein obtaining the first feedback message comprises: obtaining a third set of packets associated with the holographic communications, the third set of packets including the first feedback message, the first feedback message comprising a first identifier of the first wireless communication device, wherein outputting the second feedback message comprises: outputting a fourth set of packets including the second feedback message, the fourth set of packets output to the first wireless communication device based at least in part on the first identifier; and outputting a fifth set of packets that exclude the second feedback message, the fifth set of packets output to other wireless communication devices of the plurality of wireless communication devices.

Aspect 30: The method of aspect 24, wherein obtaining the first feedback message comprises: obtaining the first feedback message via a first channel that is different from a second channel associated with the holographic communications, wherein the first feedback message further comprises respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows, wherein outputting the second feedback message comprises: outputting the second feedback message to the one or more other wireless communications devices corresponding to the one or more other respective identifiers.

Aspect 31: The method of aspect 24, wherein obtaining the first feedback message comprises: obtaining a third set of packets associated with the holographic communications, the third set of packets including the first feedback message, wherein the first feedback message further comprises respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows, wherein outputting the second feedback message comprises: outputting a fourth set of packets including the second feedback message, the fourth set of packets output to each wireless communication device of the plurality of wireless communication devices.

Aspect 32: The method of aspect 24, wherein the first feedback message further comprises respective congestion information corresponding to one or more additional traffic flows and one or more other respective identifiers from among the one or more respective identifiers corresponding to one or more other wireless communications devices different from the first wireless communication device that are sources of packets of the one or more additional traffic flows, the method further comprising: modifying the congestion information, the one or more other respective identifiers, or both, included in the second feedback message based at least in part on the first feedback message comprising the respective congestion information and the one or more other respective identifiers of the one or more other wireless communications devices.

Aspect 33: The method of aspect 24, wherein obtaining the first feedback message comprises: obtaining the first feedback message via a first channel that is different from a second channel associated with the holographic communications, the first feedback message comprising a first identifier of the first wireless communication device, wherein outputting the second feedback message comprises: outputting the second feedback message via the first channel to one or more other wireless communication devices of the plurality of wireless communication devices.

Aspect 34: A first wireless communication device for wireless communications, comprising one or more memories storing processor-executable code, and one or more processors coupled with the one or more memories and individually or collectively operable to execute the code to cause the first wireless communication device to perform a method of any of aspects 1 through 9.

Aspect 35: A first wireless communication device for wireless communications, comprising at least one means for performing a method of any of aspects 1 through 9.

Aspect 36: A non-transitory computer-readable medium storing code for wireless communications, the code comprising instructions executable by one or more processors to perform a method of any of aspects 1 through 9.

Aspect 37: A first wireless communication device for wireless communications, comprising one or more memories storing processor-executable code, and one or more processors coupled with the one or more memories and individually or collectively operable to execute the code to cause the first wireless communication device to perform a method of any of aspects 10 through 23.

Aspect 38: A first wireless communication device for wireless communications, comprising at least one means for performing a method of any of aspects 10 through 23.

Aspect 39: A non-transitory computer-readable medium storing code for wireless communications, the code comprising instructions executable by one or more processors to perform a method of any of aspects 10 through 23.

Aspect 40: An application server for wireless communication, comprising one or more memories storing processor-executable code, and one or more processors coupled with the one or more memories and individually or collectively operable to execute the code to cause the application server to perform a method of any of aspects 24 through 33.

Aspect 41: An application server for wireless communication, comprising at least one means for performing a method of any of aspects 24 through 33.

Aspect 42: A non-transitory computer-readable medium storing code for wireless communication, the code comprising instructions executable by one or more processors to perform a method of any of aspects 24 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories storing processor-executable code; and
one or more processors coupled with the one or more memories and individually or collectively operable to execute the code to cause the first wireless communication device to:
receive a first set of packets of a traffic flow associated with holographic communications, wherein at least one packet of the first set of packets includes an explicit congestion notification marking; and
transmit, based at least in part on the explicit congestion notification marking, a feedback message comprising congestion information corresponding to the traffic flow, the feedback message further comprising an identifier of a second wireless communication device that is a source of the first set of packets.

2. The first wireless communication device of claim 1, wherein, to transmit the feedback message, the one or more processors are individually or collectively operable to execute the code to cause the first wireless communication device to:
transmit the feedback message via a first channel that is different from a second channel associated with the holographic communications.

3. The first wireless communication device of claim 1, wherein, to transmit the feedback message, the one or more processors are individually or collectively operable to execute the code to cause the first wireless communication device to:
transmit a second set of packets associated with the holographic communications, the second set of packets including the feedback message comprising the congestion information and the identifier of the second wireless communication device.

4. The first wireless communication device of claim 3, wherein the congestion information and the identifier of the second wireless communication device are included in one or more headers of the second set of packets.

5. The first wireless communication device of claim 3, wherein one or more packets of the second set of packets include the feedback message comprising the congestion information and the identifier of the second wireless communication device.

6. The first wireless communication device of claim 1, wherein the feedback message further comprises respective congestion information corresponding to one or more additional traffic flows and one or more respective identifiers of additional wireless communications devices that are sources of the one or more additional traffic flows.

7. A first wireless communication device, comprising:
one or more memories storing processor-executable code; and
one or more processors coupled with the one or more memories and individually or collectively operable to execute the code to cause the first wireless communication device to:
transmit a first set of packets of a traffic flow associated with holographic communications;
receive a feedback message comprising congestion information that is based at least in part on an explicit congestion notification marking of the first set of packets, the feedback message further comprising an identifier of the first wireless communication device, wherein the feedback message is received based at least in part on the identifier; and
modify a data rate associated with the traffic flow in accordance with the congestion information.

8. The first wireless communication device of claim 7, wherein, to receive the feedback message, the one or more processors are individually or collectively operable to execute the code to cause the first wireless communication device to:
receive the feedback message via a first channel that is different from a second channel associated with the holographic communications.

9. The first wireless communication device of claim 7, wherein, to receive the feedback message, the one or more processors are individually or collectively operable to execute the code to cause the first wireless communication device to:
receive a second set of packets associated with the holographic communications, the second set of packets including the feedback message comprising the congestion information and the identifier of the first wireless communication device.

10. The first wireless communication device of claim 9, wherein the congestion information and the identifier of the first wireless communication device are included in one or more headers of the second set of packets.

11. The first wireless communication device of claim 9, wherein one or more packets of the second set of packets include the feedback message comprising the congestion information and the identifier of the first wireless communication device.

12. The first wireless communication device of claim 7, wherein the feedback message further comprises respective congestion information corresponding to one or more additional traffic flows and one or more respective identifiers of additional wireless communications devices that are sources of packets of the one or more additional traffic flows.

13. The first wireless communication device of claim 12, wherein, to modify the data rate, the one or more processors are individually or collectively further operable to execute the code to cause the first wireless communication device to:
modify the data rate based at least in part on the respective congestion information and the one or more respective identifiers.

14. The first wireless communication device of claim 7, wherein the one or more processors are individually or collectively further operable to execute the code to cause the first wireless communication device to:
receive a second feedback message comprising respective congestion information corresponding to one or more additional traffic flows and one or more respective identifiers of additional wireless communications devices that are sources of packets of the one or more additional traffic flows.

15. An application server, comprising:
one or more memories storing processor-executable code; and
one or more processors coupled with the one or more memories and individually or collectively operable to execute the code to cause the application server to:
obtain a first set of packets of a traffic flow associated with holographic communications between a plurality of wireless communication devices, wherein the first set of packets is obtained from a first wireless communication device of the plurality of wireless communication devices;
output a second set of packets of the traffic flow, the second set of packets corresponding to the first set of packets and output to each wireless communication device of the plurality of wireless communication devices;
obtain a first feedback message comprising congestion information that is based at least in part on an explicit congestion notification marking of the first set of packets, the first feedback message further comprising one or more respective identifiers of one or more wireless communication devices of the plurality of wireless communication devices; and
output a second feedback message based at least in part on the congestion information and the one or more respective identifiers of the one or more wireless communication devices included in the first feedback message.

16. The application server of claim 15, wherein, to obtain the first feedback message, the one or more processors are individually or collectively operable to execute the code to cause the application server to:
obtain the first feedback message via a first channel that is different from a second channel associated with the holographic communications, the first feedback message comprising a first identifier of the first wireless communication device, wherein, to output the second feedback message, the one or more processors are individually or collectively operable to execute the code to cause the application server to:
output the second feedback message to the first wireless communication device via the first channel and in accordance with the first feedback message comprising the first identifier.

17. The application server of claim 15, wherein, to obtain the first feedback message, the one or more processors are individually or collectively operable to execute the code to cause the application server to:
obtain a third set of packets associated with the holographic communications, the third set of packets including the first feedback message, the first feedback message comprising a first identifier of the first wireless communication device, wherein, to output the second feedback message, the one or more processors are individually or collectively operable to execute the code to cause the application server to:
output a fourth set of packets including the second feedback message, the fourth set of packets output to each wireless communication device of the plurality of wireless communication devices.

18. The application server of claim 15, wherein, to obtain the first feedback message, the one or more processors are individually or collectively operable to execute the code to cause the application server to:
obtain a third set of packets associated with the holographic communications, the third set of packets including the first feedback message, the first feedback message comprising a first identifier of the first wireless communication device, and wherein, to output the second feedback message, the one or more processors are individually or collectively operable to execute the code to cause the application server to:
output a fourth set of packets including the second feedback message, the fourth set of packets output to the first wireless communication device based at least in part on the first identifier; and
output a fifth set of packets that exclude the second feedback message, the fifth set of packets output to other wireless communication devices of the plurality of wireless communication devices.

19. The application server of claim 15, wherein, to obtain the first feedback message, the one or more processors are individually or collectively operable to execute the code to cause the application server to:
obtain the first feedback message via a first channel that is different from a second channel associated with the holographic communications, wherein the first feedback message further comprises respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows, and wherein to output the second feedback message, the one or more processors are individually or collectively operable to execute the code to cause the application server to:
output the second feedback message to the one or more other wireless communications devices corresponding to the one or more other respective identifiers.

20. The application server of claim 15, wherein, to obtain the first feedback message, the one or more processors are individually or collectively operable to execute the code to cause the application server to:
obtain a third set of packets associated with the holographic communications, the third set of packets including the first feedback message, wherein the first feedback message further comprises respective congestion information corresponding to one or more additional traffic flows and one or more other respective identifiers from among the one or more respective identifiers corresponding to one or more other wireless communications devices different from the first wireless communication device and that are sources of packets of the one or more additional traffic flows, and wherein to output the second feedback message, the one or more processors are individually or collectively operable to execute the code to cause the application server to:
output a fourth set of packets including the second feedback message, the fourth set of packets output to each wireless communication device of the plurality of wireless communication devices.
